(19) United States
(12) Patent Application Publication
(10) Pub. No.: US 2025/0208450 A1
(43) Pub. Date: Jun. 26, 2025

(54) PHASE SHIFTER INCLUDING AN INTERLAYER FOR IMPROVED ELECTRO-OPTIC PERFORMANCE AND METHOD OF FABRICATION THEREOF

(71) Applicant: PSIQUANTUM, CORP., Palo Alto, CA (US)

(72) Inventors: Angelita Viejo RODRIGUEZ, San Jose, CA (US); Colleen FENRICH, Mountain View, CA (US); Yong LIANG, Niskayuna, NY (US)

(21) Appl. No.: 18/848,205

(22) PCT Filed: Mar. 22, 2023
(86) PCT No.: PCT/US2023/015854

§ 371 Date: Sep. 18, 2024

Related U.S. Application Data
(60) Provisional application No. 63/322,930, filed on Mar. 23, 2022.

(51) Int. Cl. G02F 1/05

(52) U.S. Cl. CPC G02F 1/05

(57) ABSTRACT

Embodiments herein relate generally to fabricating electro-optic devices such as phase shifters and switches. An electro-optic device includes an interlayer and a ferroelectric electro-optic layer. The interlayer generates a strain in the ferroelectric electro-optic layer such that an in-plane lattice constant of the ferroelectric electro-optic layer is longer than an out-of-plane lattice constant of the ferroelectric electro-optic layer. In some embodiments, a device includes a first cladding layer, a first electrode, a second electrode, a waveguide structure comprising a first material, and a second cladding layer.

### TECHNICAL FIELD

Embodiments herein relate generally to fabricating electro-optic devices such as phase shifters and switches.

### BACKGROUND

Electro-optic (EO) modulators and switches have been used in optical fields. Some EO modulators utilize free-carrier electro-refraction, free-carrier electro-absorption, the Pockel's effect, or the DC Kerr effect to modify optical properties during operation, for example, to change the phase of light propagating through the EO modulator or switch. As an example, optical phase modulators can be used in integrated optics systems, waveguide structures, and integrated optoelectronics.

Despite the progress made in the field of EO modulators and switches, there is a need in the art for improved methods and systems related to fabrication and architectures for EO modulators and switches.

### SUMMARY

In one embodiment an electro-optic device includes an interlayer and a ferroelectric electro-optic layer. The interlayer generates a strain in the electro-optic layer such that an in-plane lattice constant of the electro-optic layer is longer than an out-of-plane lattice constant of the electro-optic layer.

Some embodiments described herein relate to photonic devices and methods for fabricating photonic devices such as electro-optical switches and phase shifters.

In some embodiments, a device includes a first cladding layer, a first electrode, a second electrode, a waveguide structure comprising a first material, and a second cladding layer. The waveguide structure is coupled to the first electrode and the second electrode. In some embodiments, the first electrode and the second electrode are composed of a second material with an electron mobility higher than silicon.

In some embodiments, a device includes a first cladding layer, a first electrode, a second electrode, a second cladding layer, and a waveguide structure. The waveguide structure may include an electro-optic layer composed of a first material, a first strip waveguide portion composed of a second material, and a second strip waveguide portion composed of a third material. The electro-optic layer may be disposed between the first strip waveguide portion and the second strip waveguide portion. The electro-optic layer may be coupled to the first electrode and the second electrode.

In some embodiments, a method is described for fabricating a device.

For example, in some embodiments, a seed layer is deposited on a substrate layer, an electro-optic layer is deposited on the seed layer, a first cladding layer is deposited on the electro-optic layer. In some embodiments, a pre-fabricated first wafer comprising the stacked substrate layer, seed layer, electro-optic layer, and/or first cladding layer may be received as a starting point for further fabrication steps.

In some embodiments the first cladding layer is planarized and bonded to a second wafer. The substrate layer is removed and the seed layer is etched to split the seed layer into a first electrode separated from a second electrode. A second cladding layer is deposited on the etched seed layer. In some embodiments, the second cladding layer is etched to expose a first portion of the first electrode and a second portion of the second electrode. A first lead is deposited onto the first electrode through the exposed first portion and a second lead is deposited onto the second electrode through the exposed second portion.

In some embodiments, a seed layer is deposited on a substrate layer, an electro-optic layer is deposited on the seed layer, and an electrode layer is deposited on the electro-optic layer. In some embodiments, a pre-fabricated first wafer comprising the stacked substrate layer, seed layer, electro-optic layer, and/or electrode layer may be received as a starting point for further fabrication steps.

In some embodiments, the electrode layer is etched to expose a portion of the electro-optic layer and split the electrode layer into a first electrode separated from a second electrode. A first cladding layer is deposited on the exposed portion of the electro-optic layer and the first and second electrodes. The first cladding layer is planarized and bonded to a second wafer. The substrate layer and the seed layer are removed, and after removing the substrate layer and the seed layer, the electro-optic layer is etched to produce a ridge waveguide with a first thickness disposed between first and second slab layers with a second thickness smaller than the first thickness. A second cladding layer is deposited on the first and second slab layers and the ridge waveguide structure.

In some embodiments, a seed layer is deposited on a substrate layer, an electro-optic layer is deposited on the seed layer, and a first cladding layer is deposited on the electro-optic layer. In some embodiments, a pre-fabricated first wafer comprising the stacked substrate layer, seed layer, electro-optic layer, and/or first cladding layer may be received as a starting point for further fabrication steps.

In some embodiments, the first cladding layer is planarized and bonded to a wafer. The substrate layer and the seed layer are removed, and after removing the substrate layer and the seed layer, the electro-optic layer is etched to produce a ridge waveguide with a first thickness disposed between a first slab layer and a second slab layer, wherein the first and second slab layers have a second thickness smaller than the first thickness. First and second electrodes are deposited on the left and right sides, respectively, of the ridge waveguide structure. A second cladding layer is then deposited on the first and second electrodes and the ridge waveguide structure.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1 is a simplified schematic diagram illustrating an optical switch according to some embodiments;

FIG. 2 is a simplified schematic diagram illustrating a cross section of a waveguide structure incorporating high-K electrodes placed opposite the waveguide ridge, according to some embodiments;

FIG. 3 is a simplified schematic diagram illustrating a cross section of a waveguide structure incorporating high-K electrodes placed opposite the waveguide ridge with penetrating leads, according to some embodiments;

FIG. 4 is a simplified schematic diagram illustrating a cross section of a waveguide structure incorporating high-K electrodes placed on the same side as the waveguide ridge, according to some embodiments;

FIG. 5 is a simplified schematic diagram illustrating a cross section of a waveguide structure incorporating high-k electrodes and exhibiting a sandwich structure, according to some embodiments;

FIG. 6 is a simplified schematic diagram illustrating a cross section of a vertical waveguide structure incorporating high-k materials, according to some embodiments;

FIG. 7 is a simplified schematic diagram illustrating a cross section of a waveguide structure with the electrodes inline with the waveguide structure, according to some embodiments;

FIG. 8 is a simplified schematic diagram illustrating a cross section of a waveguide structure with electrodes exhibiting ridge-like profiles, according to some embodiments;

FIG. 9 is a simplified schematic diagram showing a top view of a waveguide structure, according to some embodiments;

FIG. 10 is an illustration of a user interfacing with a hybrid quantum computing device, according to some embodiments;

FIG. 11 is a simplified schematic diagram illustrating a cross section of a waveguide structure that shows the direction of an induced electric field, according to some embodiments;

FIGS. 12A-G are schematic diagrams illustrating a fabrication method for constructing the electro-optical device with a ridge waveguide positioned opposite to the electrodes, according to some embodiments;

FIGS. 13A-E are schematic diagrams illustrating a fabrication method for constructing the electro-optical device with a ridge waveguide positioned on the opposite side as the electrodes with leads penetrating through the waveguide, according to some embodiments;

FIGS. 14A-E are schematic diagrams illustrating a fabrication method for constructing the electro-optical device with a ridge waveguide positioned on the same side as the electrodes, according to some embodiments;

FIGS. 15A-E are schematic diagrams illustrating a fabrication method for constructing a photonic device exhibiting a sandwich architecture, according to some embodiments; and

FIG. 16 is a schematic diagram of a pre-fabricated wafer comprising stacked layers, according to some embodiments.

FIG. 17 is a plot of the effective Pockels coefficient versus temperature for BTO.

FIG. 18A is an illustration of the crystallographic unit cell of BTO in the cubic phase.

FIG. 18B is an illustration of the crystallographic unit cell of BTO in the tetragonal phase.

FIG. 18C is a schematic illustration of a first symmetry phase of BTO vs. temperature.

FIG. 18D is a schematic illustration of a further symmetry phase of BTO vs. temperature.

FIG. 18E is a schematic illustration of a further symmetry phase of BTO vs. temperature.

FIG. 18F is a schematic illustration of a further symmetry phase of BTO vs. temperature.

FIG. 19A is a vertical cross-sectional view of an electro-optic device having an interlayer that may be used to generate a predetermined strain in an electro-optic material, according to various embodiments.

FIG. 19B is a schematic illustration of a compositional gradient of the interlayer of FIG. 19A, according to an embodiment.

FIG. 19C is a graphical illustration of the compositional gradient of the interlayer of FIG. 19A, according to an embodiment.

FIG. 20A is a vertical cross-sectional view of a further electro-optic device having an interlayer that may be used to generate a predetermined strain in an electro-optic material, according to various embodiments.

FIG. 20B is a schematic illustration of a composition profile of the interlayer of FIG. 20A, according to an embodiment.

FIG. 20C is a graphical illustration of the composition profile of the interlayer of FIG. 20A, according to an embodiment.

FIG. 21 is a vertical cross-sectional view of another electro-optic device having an interlayer that may be used to generate a predetermined strain in an electro-optic material, according to various embodiments

FIG. 22 is a schematic plot of lattice constant versus distance along the layers of an electro-optic device, according to various embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electrode layer could be termed a second electrode layer, and, similarly, a second electrode layer could be termed a first electrode layer, without departing from the scope of the various described embodiments. The first electrode layer and the second electrode layer are both electrode layers, but they are not the same electrode layer.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

Embodiments of the present invention relate to optical systems. More particularly, embodiments of the present invention utilize high dielectric constant materials (i.e., high-k materials) in optical modulators and switches to reduce power consumption during operation. It is noted that, as used herein, a “high dielectric constant material” is intended to refer to a material with a high dielectric permittivity compared to other materials within operative components of the optical modulator or switch, and in particular compared to the material used to construct the waveguide. Merely by way of example, embodiments of the present invention are provided in the context of integrated optical systems that include active optical devices, but the invention is not limited to this example and has wide applicability to a variety of optical and optoelectronic systems.

According to some embodiments, the active photonic devices described herein utilize electro-optic effects, such as free carrier induced refractive index variation in semiconductors, the Pockels effect, and/or the DC Kerr effect to implement modulation and/or switching of optical signals. Thus, embodiments of the present invention are applicable to both modulators, in which the transmitted light is modulated either ON or OFF, or light is modulated with a partial change in transmission percentage, as well as optical switches, in which the transmitted light is output on a first output (e.g., waveguide) or a second output (e.g., waveguide) or an optical switch with more than two outputs, as well as more than one input. Thus, embodiments of the present invention are applicable to a variety of designs including an M (input)×N (output) systems that utilize the methods, devices, and techniques discussed herein. Some embodiments also relate to electro-optic phase shifter devices, also referred to herein as phase adjustment sections, that may be employed within switches or modulators.

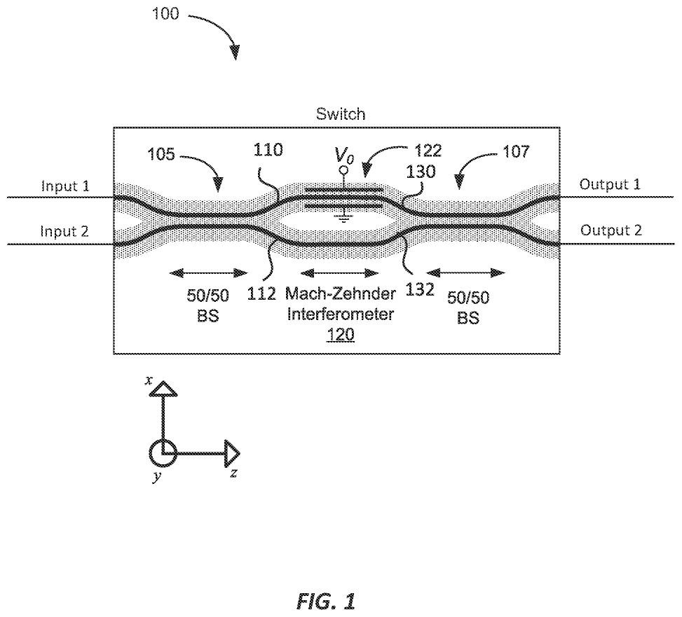

FIG. 1 is a simplified schematic diagram illustrating an optical switch according to an embodiment of the present invention. Referring to FIG. 1, switch 100 includes two inputs: Input 1 and Input 2 as well as two outputs: Output 1 and Output 2. As an example, the inputs and outputs of switch 100 can be implemented as optical waveguides operable to support single mode or multimode optical beams. As an example, switch 100 can be implemented as a Mach-Zehnder interferometer integrated with a set of 50/50 beam splitters 105 and 107, respectively. As illustrated in FIG. 1, Input 1 and Input 2 are optically coupled to a first 50/50 beam splitter 105, also referred to as a directional coupler, which receives light from the Input 1 or Input 2 and, through evanescent coupling in the 50/50 beam splitter, directs 50% of the input light from Input 1 into waveguide 110 and 50% of the input light from Input 1 into waveguide 112. Concurrently, first 50/50 beam splitter 105 directs 50% of the input light from Input 2 into waveguide 110 and 50% of the input light from Input 2 into waveguide 112. Considering only input light from Input 1, the input light is split evenly between waveguides 110 and 112.

Mach-Zehnder interferometer 120 includes phase adjustment section 122. Voltage V₀ can be applied across the waveguide in phase adjustment section 122 such that it can have an index of refraction in phase adjustment section 122 that is controllably varied. Because light in waveguides 110 and 112 still have a well-defined phase relationship (e.g., they may be in-phase, 180° out-of-phase, etc.) after propagation through the first 50/50 beam splitter 105, phase adjustment in phase adjustment section 122 can introduce a predetermined phase difference between the light propagating in waveguides 130 and 132. As will be evident to one of skill in the art, the phase relationship between the light propagating in waveguides 130 and 132 can result in output light being present at Output 1 (e.g., light beams are in-phase) or Output 2 (e.g., light beams are out of phase), thereby providing switch functionality as light is directed to Output 1 or Output 2 as a function of the voltage V₀ applied at the phase adjustments section 122. Although a single active arm is illustrated in FIG. 1, it will be appreciated that both arms of the Mach-Zehnder interferometer can include phase adjustment sections.

As illustrated in FIG. 1, electro-optic switch technologies, in comparison to all-optical switch technologies, utilize the application of the electrical bias (e.g., V₀ in FIG. 1) across the active region of the switch to produce optical variation. The electric field and/or current that results from application of this voltage bias results in changes in one or more optical properties of the active region, such as the index of refraction or absorbance.

Although a Mach-Zehnder interferometer implementation is illustrated in FIG. 1, embodiments of the present invention are not limited to this particular switch architecture and other phase adjustment devices are included within the scope of the present invention, including ring resonator designs, Mach-Zehnder modulators, generalized Mach-Zehnder modulators, and the like. One of ordinary skill in the art would recognize many variations, modifications, and alternatives.

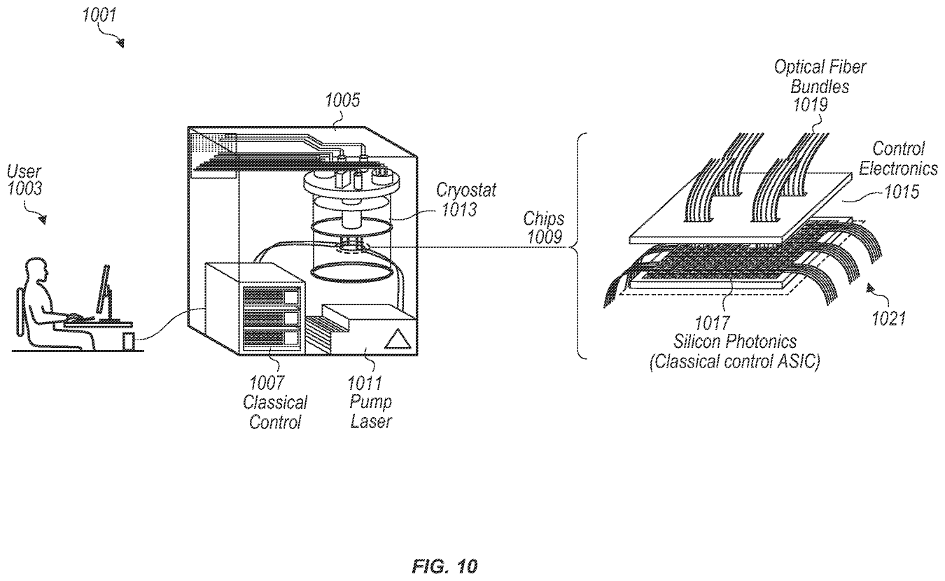

In some embodiments, the optical phase shifter devices described herein may be utilized within a quantum computing system such as the hybrid quantum computing system shown in FIG. 10. Alternatively, these optical phase shifter devices may be used in other types of optical systems. For example, other computational, communication, and/or technological systems may utilize photonic phase shifters to direct optical signals (e.g., single photons or continuous wave (CW) optical signals) within a system or network, and phase shifter architectures described herein may be used within these systems, in various embodiments.

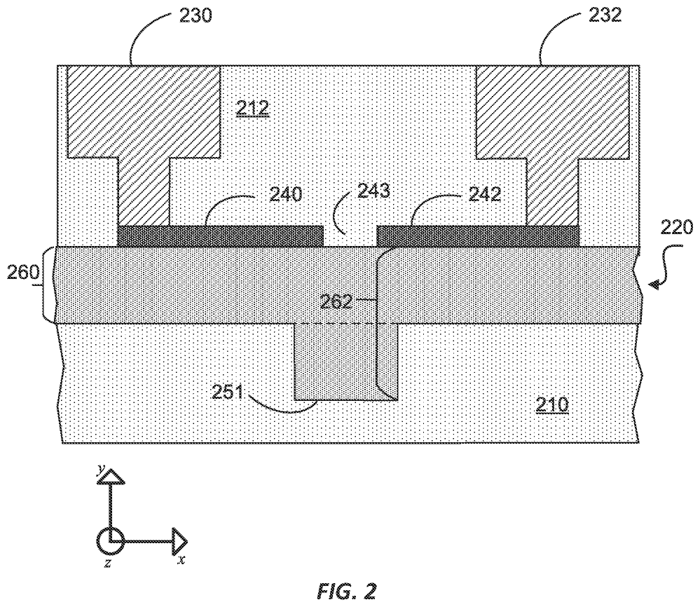

### FIGS. 2-8—Cross Sections of Photonic Phase Shifters

FIGS. 2-8 are simplified cross-section diagrams illustrating various architectures for a photonic phase shifter, according to various embodiments. Note that the architectures shown in FIGS. 2-8 are schematic illustrations, and are not necessarily drawn to scale. While the architectures shown in FIG. 2-8 differ in several important design features, they also share some features in common. For example, as described in greater detail below, each of FIGS. 2-8 exhibit two electrical contacts, and each electrical contact includes a lead (230, 330, 430, 530, 630, 730, and 830, as well as 232, 332, 432, 532, 632, 732, and 832) connected to an electrode (240, 340, 440, 540, 640, 740, and 840, as well as 242, 342, 442, 542, 642, 742, and 842). It is noted that, as used herein, the term “electrode” refers to a device component that directly couples to the waveguide structure (e.g., to alter the voltage drop across the waveguide structure and actuate a photonic switch). Further, the term “lead” refers to a backend structure that couples the electrodes to other components of the device (e.g., the leads may couple the electrodes to a controllable voltage source), but the leads are isolated from and do not directly couple to the waveguide structure. In some embodiments, the leads may be composed of a metal (e.g., copper, gold, etc.), or alternatively, a semiconductor material.

The electrodes are configured to extend in close proximity to the location of the optical mode in the waveguide, and the photonic phase shifter is configured such that a controllable voltage difference may be introduced across the two electrodes (e.g., dielectric electrodes in some embodiments), to alter the accumulated phase of a photonic mode travelling through the waveguide. For example, the electrodes may be coupled, via the leads, to a voltage source that imposes the controllable voltage difference.

In some embodiments, the electrodes may be composed of a high-k dielectric material with a large dielectric constant, such that the electrodes have a larger dielectric constant than the material of the waveguide and/or the slab layer. As used herein, K is used to represent the dielectric constant, which refers to the real component of the relative permittivity, κ=Re(εᵣ)=Re(ε/ε₀), where εᵣ is the complex-valued relative permittivity, ε is the absolute permittivity of the material, and co is the permittivity free space. It is noted for clarity that the imaginary component of εᵣ is related to the conductivity of the material, whereas the real component, K, is related to the dielectric polarizability of the material.

The dielectric constant of a material may have a different value in the presence of a direct current (DC) voltage compared to an (AC) voltage, and the dielectric constant of the material in an AC voltage may be a function of frequency, κ(ω). Accordingly, in some embodiments, when selecting a material for the electrodes, the slab layer, and/or the ridge waveguide, the dielectric constant of the material may be considered at the operating frequency of the photonic phase shifter.

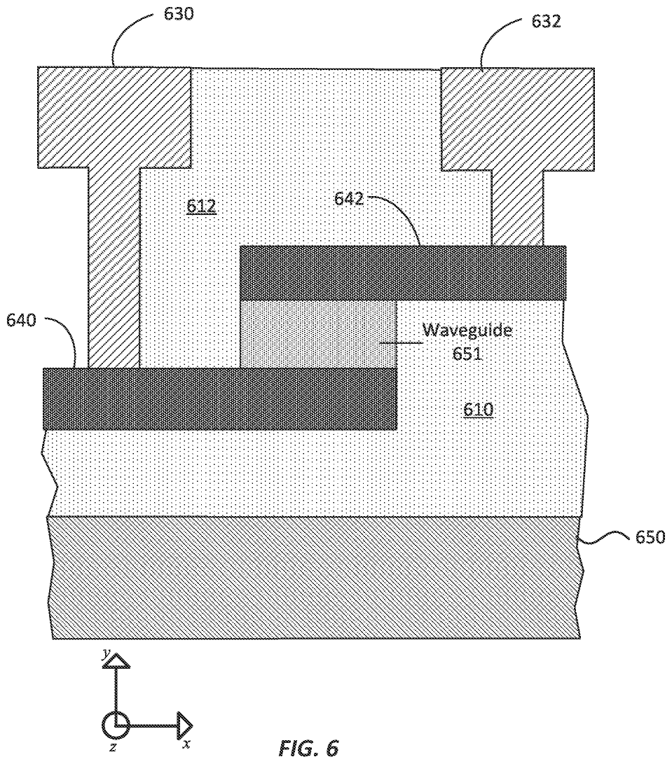

The electrodes may be composed of a material with a higher dielectric constant along the direction separating the first and second electrodes (e.g., the x-direction in FIGS. 2-5 and 7-8, or the y-direction in FIG. 6) than the first material of the slab layer. For example, in anisotropic media, the permittivity tensor ε may be expressed by the following matrix which relates the electric field E to the electric displacement D.

$$[ \begin{matrix}{D}_{x} ( \text{?} ) \\ {D}_{y} ( \text{?} ) \\ {D}_{z} ( \text{?} )\end{matrix} ] = [ \begin{matrix}{ε}_{xx} & {ε}_{xy} & {ε}_{xz} \\ {ε}_{yx} & {ε}_{yy} & {ε}_{yz} \\ {ε}_{zx} & {ε}_{zy} & {ε}_{zz}\end{matrix} ] [ \begin{matrix}{E}_{x} ( \text{?} ) \\ {E}_{y} ( \text{?} ) \\ {E}_{z} ( \text{?} )\end{matrix} ] , \qquad ( 1 )$$

$$\text{?} \text{indicates text missing or illegible when filed}$$

where the components εₓₓ, ε_{xy}, etc., denote the individual components of the permittivity tensor. In some embodiments, the material of the first and second electrodes may be selected such that the diagonal component of the permittivity tensor along the direction separating the electrodes is larger than the corresponding diagonal component of the permittivity tensor of the material of the slab layer and/or the ridge portion.

TABLE 1
χ⁽³⁾, Refractive Index, and Dielectric
Constant Values for Various Materials

| | | Refractive | |
|---|---|---|---|
| | | Index (at | Dielectric |
| Material | χ⁽³⁾ (m²/W) | 1.55 μm) | Constant |
| Si | 2.2 × 10⁻¹⁸ | ~3.5 | 11.7 |
| Si₃N₄ | 2 × 10⁻¹⁹ | 2 | 7-8 |
| | 1.6 × 10⁻¹⁸ | 2.5 | |
| | 2 × 10⁻¹⁸ | 2.7 | |
| Ta₂O₅ | 1 × 10⁻¹⁸-4 × 10⁻¹⁸ | 2.08 | 25-50 |
| TiO₂ | 5 × 10⁻¹⁸-6 × 10⁻¹⁷ | 2.27-2.6 | 10-85 |
| Graphene | 4.5 × 10⁻¹⁴ | 2.2 (at 1.2 μm) | 2-50 |
| Oxide | | | |
| STO | | ~2.3 | 10,000-24,000 |
| | | | (below 10K) |
| BTO | r42 >150 pm/V | ~2.3 | 150-200 |
| | | | (below 10K) |
| | | | 1000 to 3000 |
| | | | (at 300K) |

Table 1 illustrates the X⁽³⁾ refractive index, and dielectric constant values for a variety of materials. As shown in Table 1, STO has an extremely high dielectric constant for temperatures below 10K, such that STO may be a desirable material to use for the electrodes, while BTO may be used for the slab layer and/or ridge portion of the waveguide, in some embodiments.

As illustrated, the architectures shown in each of FIGS. 2-8 exhibit a photonic device comprising first and second cladding layers. For example, the regions marked 210, 310, 410, 510, 610, 710, and 810 represent first cladding layers on one side of the waveguide, while the regions marked 212, 312, 412, 512, 612, 712, and 812 represent second cladding layers on the other side of the waveguide. It is noted that the terms “first” and “second” are meant simply to distinguish between the two cladding layers, and, for example, the term “first cladding layer” may refer to the cladding layer on either side of the waveguide. The index of refraction of the first and second cladding layers may be lower than the index of refraction of the waveguide structure, in some embodiments.

FIGS. 2-8 further exhibit a first electrical contact including a first lead (230, 330, 430, 530, 630, 730, and 830) coupled to a first electrode (240, 340, 440, 540, 640, 740, and 840) and a second electrical contact including a second lead (232, 332, 432, 532, 632, 732, and 842) coupled to a second electrode (242, 342, 442, 542, 642, 742, and 842). The first and second leads may be composed of a conducting material such as a metal, or alternatively they may be composed of a semiconductor material. In various embodiments, the first electrode and the second electrode are composed of one or more of gallium arsenide (GaAs), an aluminum gallium arsenide (AlₓG₁₋ₓAs)/GaAs heterostructure, an indium gallium arsenide (InGaAs)/GaAs heterostructure, zinc oxide (ZnO), zinc sulfide (ZnS), indium oxide (InO), doped silicon, strontium titanate (STO), doped STO, barium titanate (BTO), barium strontium titanate (BST), hafnium oxide, lithium niobite, zirconium oxide, titanium oxide, graphene oxide, tantalum oxide, lead zirconium titanate (PZT), lead lanthanum zirconium titanate (PLZT), strontium barium niobate (SBN), aluminum oxide, aluminum oxide, doped variants or solid solutions thereof, or a two-dimensional electron gas. For embodiments where the first and second electrodes are composed of doped STO, the STO may be either niobium doped, lanthanum doped, or vacancy doped, according to various embodiments.

FIGS. 2-8 illustrate a waveguide structure including a slab layer (220, 320, 420, and 520, 651, 754, and 851) comprising a first material, wherein the slab layer is coupled to the first electrode of the first electrical contact and the second electrode of the second electrical contact. In some embodiments, the waveguide structure further includes a ridge portion (251, 351, 451, and 551) composed of the first material (or a different material) and coupled to the slab layer, where the ridge portion is disposed between the first electrical contact and the second electrical contact. In various embodiments, the first material is one of strontium titanate (STO), barium titanate (BTO), barium strontium titanate (BST), hafnium oxide, lithium niobite, zirconium oxide, titanium oxide, graphene oxide, tantalum oxide, lead zirconium titanate (PZT), lead lanthanum zirconium titanate (PLZT), strontium barium niobate (SBN), aluminum oxide, aluminum oxide, or doped variants or solid solutions thereof. The first material may be a transparent material having an index of refraction that is larger than an index of refraction of the first and second cladding layers, in some embodiments.

In some embodiments, a second material composing the first and second electrodes may be selected based on the first material composing the slab layer and/or the waveguide structure. For example, the second material may be selected such that the second material has a larger dielectric constant than the dielectric constant of the first material. As one example, if the first material is BTO, the second material may be selected to be STO, which has a larger dielectric constant than BTO at the cryogenic temperatures (e.g., 4K) at which the photonic device is intended to operate. Advantageously, the large dielectric constant of the electrodes may enable the electrodes to be placed in closer proximity to the waveguide compared to metallic electrodes, for a given acceptable level of loss from the waveguide into the electrodes. For example, the high conductivity of a metallic electrode will result in a larger degree of photon absorption (i.e., loss) from the waveguide compared to the absorption of a electrode at the same separation from the waveguide. Accordingly, the electrodes may be placed in closer proximity to the waveguide than metallic electrodes for a given loss tolerance. The high dielectric constant of the electrodes corresponds to a high polarizability of the dielectric material, which in turn results in an energy-efficient control mechanism to adjust the electric field within the waveguide structure.

In some embodiments, the materials used for the electrodes, and the waveguide structure may be selected based on their effective dielectric constants. For example, while the dielectric constant (or the dielectric tensor for anisotropic materials) of a material is an intrinsic material property, the effective dielectric constant of a structure is proportional to its dielectric constant but also depends on the shape and dimensions of the structure. In these embodiments, the material used for the first and second electrodes may be selected such that the effective dielectric constant of the first and second electrodes is greater than an effective dielectric constant of the waveguide structure.

In some embodiments, a cryogenic device such as the cryostat 1113 shown in FIG. 10 may be configured to maintain the first electrical contact, the second electrical contact, and the waveguide structure at a cryogenic temperature, e.g., at or below 77 Kelvin.

In some embodiments, the first electric contact and the second electrical contact are configured to generate an electric field along one or more directions, e.g., along the x-direction in the waveguide structure, and the waveguide structure may be characterized by an electro-optic coefficient, (e.g., X⁽²⁾, the Pockel's coefficient, or X⁽³⁾), the Kerr coefficient) having a non-zero value aligned along the direction of the electric field. For example, the leads may be coupled to a voltage source that imposes a controllable (e.g., programmable) voltage difference, thereby generating an electric field in the waveguide structure, as illustrated in FIG. 10. Additionally or alternatively, a guided mode supported by the waveguide structure may have a direction of polarization aligned with the x-direction.

In some embodiments, the first electrode and the second electrode are configured as a second layer coplanar to the slab layer and disposed adjacent to a first side of the slab layer. For example, the first and second electrodes may be grown (e.g., using epitaxy or another method such as metal organic chemical vapor deposition, molecular beam epitaxy, physical vapor deposition, sol-gel, etc.) onto the first side of the slab layer, such that the first and second dielectric layers are directly coupled to the slab layer. Alternatively, in some embodiments an intervening layer may be disposed between the slab layer and the first and second dielectric layer, such that the slab layer and the first and second dielectric layers are indirectly coupled. The intervening layer may be composed of an oxide material, in some embodiments.

The first electrode and the second electrode may be separated by a gap region, e.g., gap region 243 or 343. In some embodiments, the gap region may have been etched out, and may be filled with a cladding material. In some embodiments, both the first and second electrodes may be grown as a single second layer over the slab layer, and a region may be subsequently etched out to separate the first and second electrodes. This etched region may be subsequently filled with a cladding material. Alternatively, the etched region may be left empty (i.e., may be filled with air or vacuum).

In some embodiments, the first electrode and the second electrode have a dielectric constant greater than a dielectric constant of the first material in the direction separating the first and second electrodes. The dielectric constant of the first electrode and the second electrode may be greater than the dielectric constant of the waveguide structure at a first temperature that is greater than 1 mK, less than 77 K, less than 150 K, and/or within another temperature range. In some embodiments, the first material is a transparent material having an index of refraction that is larger than an index of refraction of the first and second cladding layers. In some embodiments, a ratio between the dielectric constant of the first and second electrodes and the dielectric constant of the first material is 2 or greater.

### Transparent Electrodes

The electrical conductivity of a material is proportional to both its carrier mobility (e.g., electron mobility or hole mobility) and carrier concentration (e.g., its free electron density or hole density). Increased conductivity of the electrodes of a photonic phase shifter device may be desirable, as it may enable increased control of the device at higher frequencies and/or with reduced heating of the electrodes. However, a large free electron density of the electrodes may be undesirable, as an electrode with a large free electron density may provide a large absorptive reservoir for photons within the waveguide structure to be absorbed by the free electrons of the electrode (e.g., thereby escaping out of the waveguide structure and into the electrodes). Said another way, increasing the conductivity of the electrodes by increasing the free electron density of the material selected for the electrodes may be undesirable, as this may increase the photonic loss rate of the device.

To address these and other concerns, in some embodiments, the electrodes may be composed of a second material that is selected to have a high conductivity by virtue of its high carrier mobility, rather than due to its high carrier concentration. Advantageously, the high carrier mobility material may produce a proportionally high conductivity without introducing high photon absorption. A high carrier mobility material may exhibit desirable conductivity properties while maintaining transparency to optical modes within the waveguide by virtue of its relatively lower carrier concentration (e.g., low relative to a material with a similar conductivity and a low carrier mobility). Classical Drude theory predicts that free carrier absorption is proportional to the doping level and inversely proportional to the optical mobility. Accordingly, materials with high mobility may exhibit both decrease resistance and free carrier absorption.

For example, in some embodiments the first electrode and the second electrode are composed of a second material, where the second material has a high carrier mobility (e.g., a high electron mobility or a high hole mobility). As one example, the second material may be selected such that its electron mobility is higher than silicon. In some embodiments, the second material may be selected such that it has a band gap larger than an operating frequency of the device.

In some embodiments, the second material comprises one of gallium arsenide (GaAs), an aluminum gallium arsenide (AlₓG₁₋ₓAs)/GaAs heterostructure, an indium gallium arsenide (InGaAs)/GaAs heterostructure, zinc oxide (ZnO), zinc sulfide (ZnS), indium oxide (InO), doped silicon, a two-dimensional electron gas, or doped strontium oxide (STO). For embodiments where the second material comprises doped STO, the doped STO may be either niobium doped, lanthanum doped, or vacancy doped, among other possibilities. For example, bulk GaAs has an electron mobility of 8500 cm²/Vs, which is 6 times higher than the electron mobility of silicon. Heterostructures of InGaAs/GaAs may reach mobilities of 41,000 cm²/Vs at 4 Kelvin and AlₓG₁₋ₓ As/GaAs heterostructures may reach mobilities of up to 180,000 cm²/Vs. In comparison, Si has a mobility of 1,500 cm²/Vs. Doped STO may also exhibit high electron mobilities, from 10,000 cm²/Vs to 53,000 cm²/Vs, depending on carrier concentration.

For embodiments where the second material is a doped material, the doping concentration may be selected based on the absorptive properties of the resultant doped material. For example, the absorption of the doped material may be analyzed at the operating frequency or frequencies of the electro-photonic device for each of a plurality of doping concentrations, and a doping concentration may be selected which exhibits low absorption at the operating frequency or frequencies.

The following paragraphs describe various design features that differ between the architectures shown in FIGS. 2-8.

FIG. 2 illustrates an architecture where the ridge portion of the waveguide structure (251) is disposed on the bottom of the slab layer and extends into the first cladding layer (210). As illustrated in FIG. 2, the combination of the ridge portion and the slab layer has a first thickness (262) greater than a second thickness (260) of the slab layer alone (220), and the excess of the first thickness relative to the second thickness extends into the cladding layer (210) on the bottom side of the slab layer. As illustrated in FIG. 2, the first electrode (240) and the second electrode (242) are coupled to the slab layer (220) on the top side of the slab layer opposite the bottom side. Further, the first electrical contact (230) and the second electrical contact (232) are disposed on the top side of the slab layer (220). It should be noted that the terms “top” and “bottom” are used for clarity in reference to the perspective illustrated in the Figures, and do not necessarily refer to any particular orientation relative to the overall device.

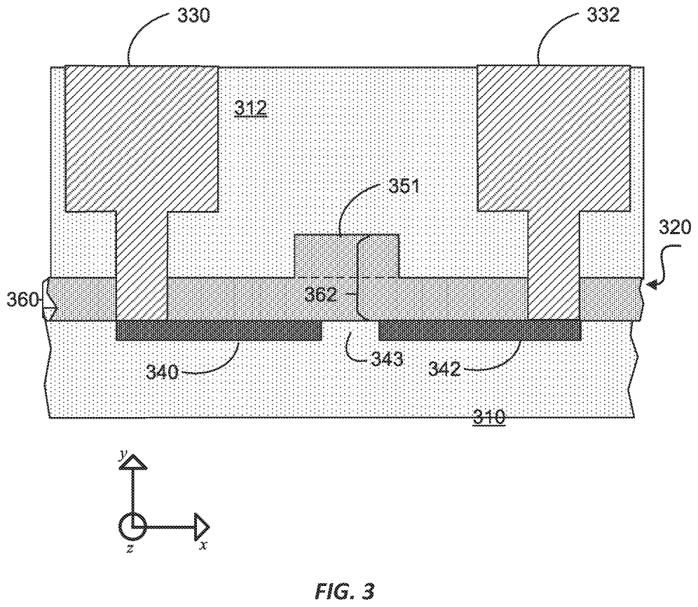

FIG. 3 illustrates an architecture where the ridge portion of the waveguide structure (351) is disposed on the top side of the slab layer and extends into a first cladding layer (312), the first electrode and the second electrode are coupled to the slab layer on the bottom side of the slab layer opposite the top side. As illustrated, the combination of the ridge portion and the slab layer has a first thickness (362) greater than a second thickness (360) of the slab layer alone (320), and the excess of the first thickness relative to the second thickness extends into the first cladding layer (312) on the top side of the slab layer (320). As illustrated in FIG. 3, the first electrode (340) and the second electrode (342) are coupled to the slab layer (320) on the bottom side of the slab layer opposite the top side. Further, the first electrical contact (330) is coupled to the first electrode (340) by penetrating through the slab layer (320) from the top side of the slab layer to the bottom side of the slab layer, and the second electrical contact (332) is coupled to the second electrode (342) by penetrating through the slab layer (320) from the top side of the slab layer to the bottom side of the slab layer.

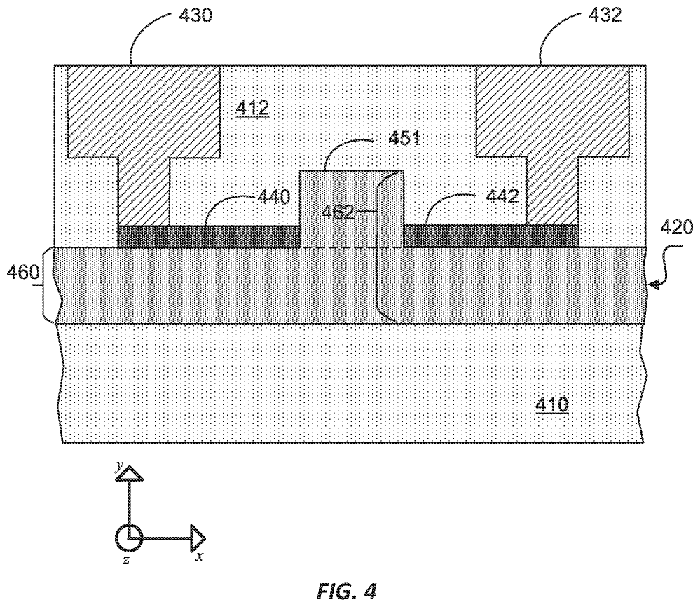

FIG. 4 illustrates an architecture where the combination of the slab layer and the ridge portion of the waveguide structure (451) has a first thickness (462) greater than a second thickness (460) of the slab layer (420), and the excess of the first thickness relative to the second thickness extends into the first cladding layer (412) on the top side of the slab layer. As illustrated in FIG. 4, the first electrode (440) and the second electrode (442) are coupled to the first material (420) on the top side of the slab layer. Further the first electrode (440) and the second electrode (442) abut the ridge portion of the waveguide structure (451).

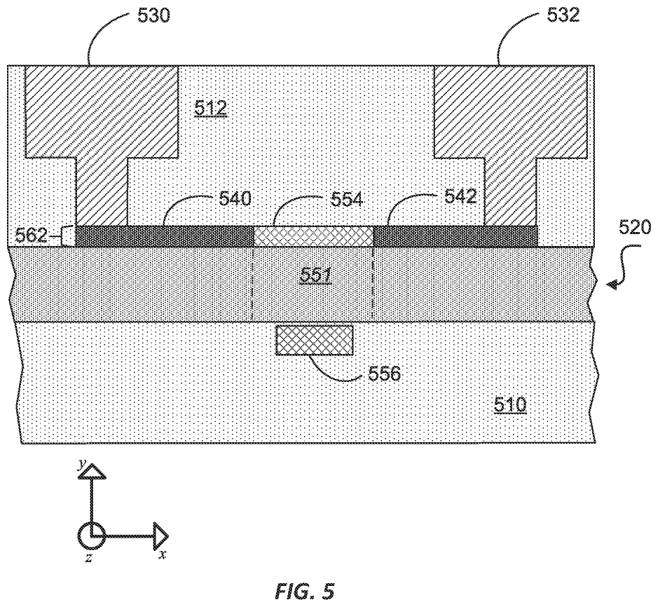

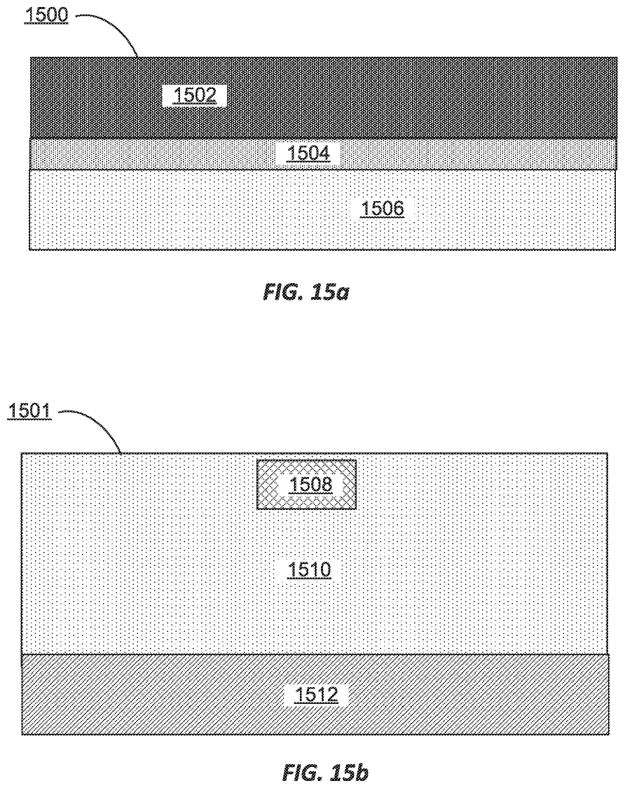

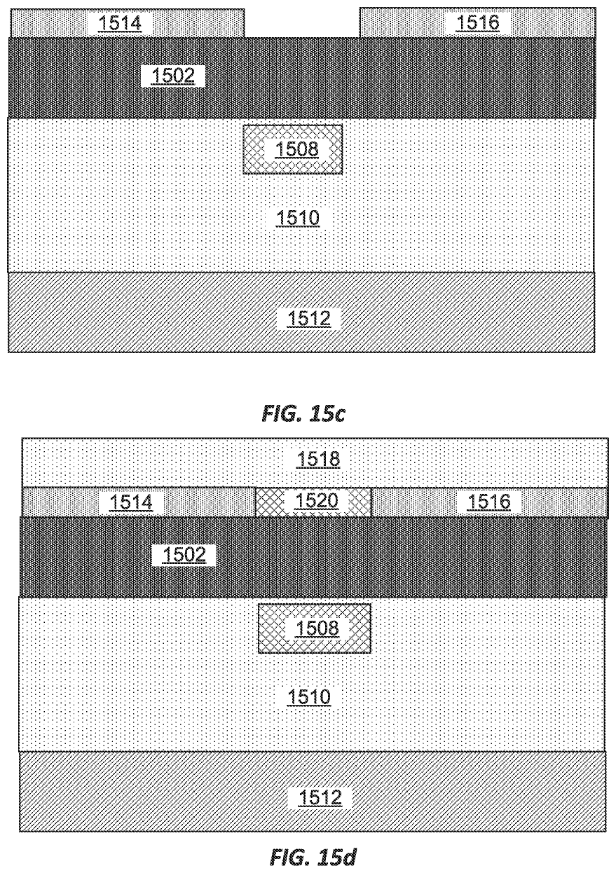

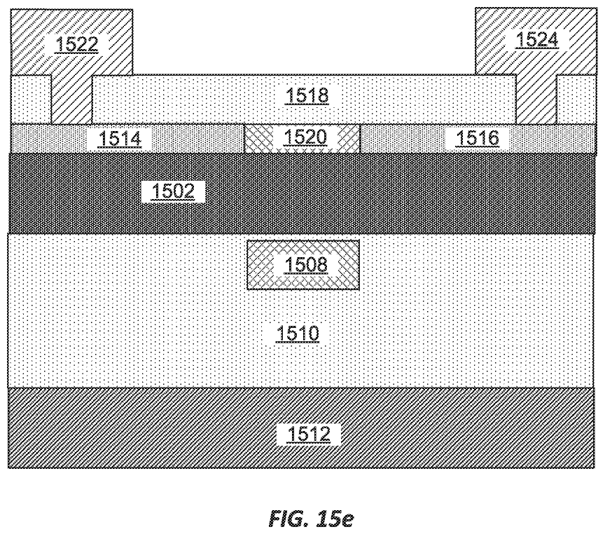

FIG. 5 illustrates an architecture where the waveguide structure includes a first strip waveguide portion (554) and a second strip waveguide portion (556), where the first and second waveguide portions are composed of a second material, and where the slab layer (520) is disposed between the first waveguide portion (554) and the second waveguide portion (556). A first electrode (540) and a second electrode (542) are disposed on the electro-optic layer (520), a first lead (530) is coupled to the first electrode, and a second lead (532) is coupled to the second electrode. The device architecture illustrated in FIG. 5 may be fabricated by the method described in reference to FIG. 15, according to some embodiments.

In some embodiments, the first strip waveguide portion is composed of silicon nitride (Si3N4) and the second strip waveguide portion is composed of silicon. In other embodiments, both the first and second strip waveguide portions are composed of silicon nitride (Si₃N₄). Alternatively, each of the first and second waveguide portions may separately be composed of Si₃N₄, silicon dioxide (SiO₂), aluminum oxide (Al₂O₃), or another material.

As illustrated in FIG. 5, the first electrode and the second electrode abut the first strip waveguide, and the first electrical electrode and the second electrode have a first thickness (562). In some embodiments, the first electrode and the second electrode comprise a second layer coplanar to the electro-optic layer and disposed adjacent to a first side of the electro-optic layer.

In some embodiments, the first and second strip waveguide portions are configured to concentrate the maximum intensity portion of an optical mode within the electro-optic layer. In other words, having only a first strip waveguide portion (554) on one side of the slab layer (520) and a cladding layer on the other side (i.e., without the second strip waveguide portion 556), or having only a second strip waveguide portion (556) on one side of the slab layer (520) and a cladding layer on the other side (i.e., without the first strip waveguide portion 554) may result in a vertically offset and/or less concentrated optical mode. In some embodiments, the first strip waveguide portion abuts the slab layer and the second strip waveguide portion is separated by a small distance (e.g., several nanometers or another distance) from the slab layer. Alternatively, (not shown in FIG. 5), both the first and second strip waveguide portions may about the slab layer.

FIG. 6 illustrates a vertical waveguide architecture where the first electrode (642) is coupled to the slab layer (651) on the top side of the slab layer and the second electrode (640) is coupled to the slab layer (651) on the bottom side of the slab layer opposite the top side. In other words, the first and second electrodes are coupled to the top and bottom sides of the waveguide structure, such that the induced electric field within the waveguide structure is oriented along the y-direction.

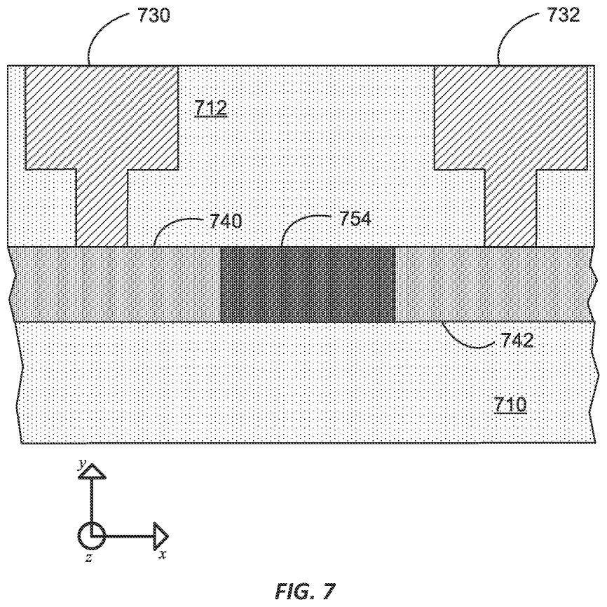

FIG. 7 illustrates a waveguide architecture where each of the first (740) and second (742) electrodes are disposed inline with the waveguide structure (754). In other words, each of the first and second electrodes and the waveguide structure are disposed within a single layer with a single width.

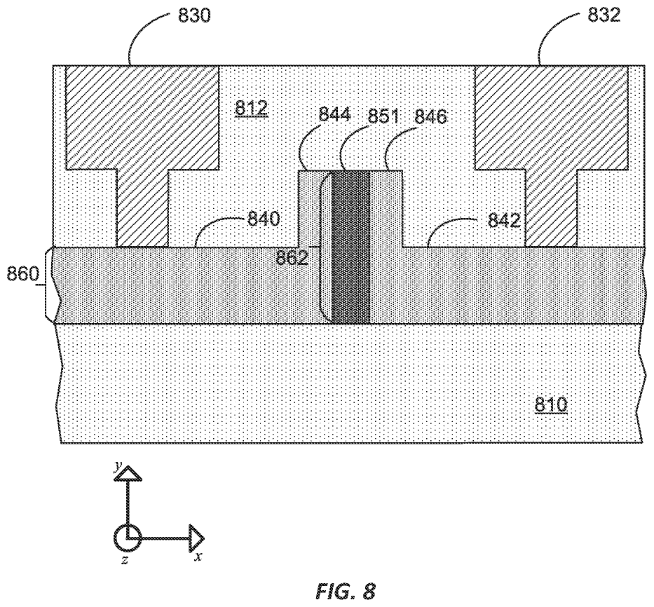

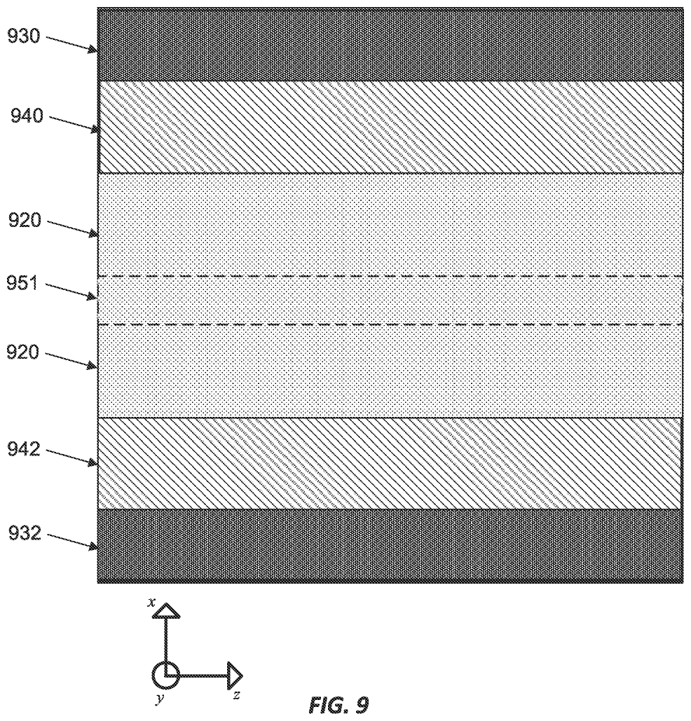

FIG. 8 illustrates a waveguide architecture where the first (840) and second (842) electrodes share a ridge-like profile with the waveguide structure (851), where the ridge-like profile extends into the first cladding layer (812). For example, the first electrode (840) may include a ridge portion (844) having a thickness (862) that is greater than a thickness (860) of the remainder of the first electrode, and the second electrode (842) may include a ridge portion (846) having a thickness (862) that is greater than the thickness (860) of the remainder of the second electrode. Further, the ridge portions of the first and second electrodes may exhibit the same thickness as the waveguide structure (851).

### FIG. 9—Top-Down View of Photonic Phase-Shifter

FIG. 9 is a top-down view of a photonic phase-shifter architecture, according to some embodiments. As illustrated, the phase-shifter may include first (930) and second (932) leads, first (940) and second (942) electrodes, a slab (e.g., waveguide) layer (920), and a ridge portion of the waveguide structure (951).

### FIG. 10—Hybrid Quantum Computing System

FIG. 10 is a simplified system diagram illustrating incorporation of an electro-optic switch with a cryostat into a hybrid quantum computing system, according to some embodiments. In order to operate at low temperatures, for example liquid helium temperatures, embodiments of the present invention integrate the electro-optic switches discussed herein into a system that includes cooling systems. Thus, embodiments of the present invention provide an optical phase shifter that may be used within a hybrid computing system, for example, as illustrated in FIG. 8. The hybrid computing system 1101 includes a user interface device 1103 that is communicatively coupled to a hybrid quantum computing (QC) sub-system 1105. The user interface device 1103 can be any type of user interface device, e.g., a terminal including a display, keyboard, mouse, touchscreen and the like. In addition, the user interface device can itself be a computer such as a personal computer (PC), laptop, tablet computer and the like. In some embodiments, the user interface device 1103 provides an interface with which a user can interact with the hybrid QC subsystem 1105. For example, the user interface device 1103 may run software, such as a text editor, an interactive development environment (IDE), command prompt, graphical user interface, and the like so that the user can program, or otherwise interact with, the QC subsystem to run one or more quantum algorithms. In other embodiments, the QC subsystem 1105 may be pre-programmed and the user interface device 1103 may simply be an interface where a user can initiate a quantum computation, monitor the progress, and receive results from the hybrid QC subsystem 1105. Hybrid QC subsystem 1105 further includes a classical computing system 1107 coupled to one or more quantum computing chips 1109. In some examples, the classical computing system 1107 and the quantum computing chip 1109 can be coupled to other electronic components 1111, e.g., pulsed pump lasers, microwave oscillators, power supplies, networking hardware, etc.

In some embodiments that utilize cryogenic operation, the quantum computing chip 1109 can be housed within a cryostat, e.g., cryostat 1113. In some embodiments, the quantum computing chip 1109 can include one or more constituent chips, e.g., hybrid electronic chip 1115 and integrated photonics chip 1117. Signals can be routed on- and off-chip any number of ways, e.g., via optical interconnects 1119 and via other electronic interconnects 1121.

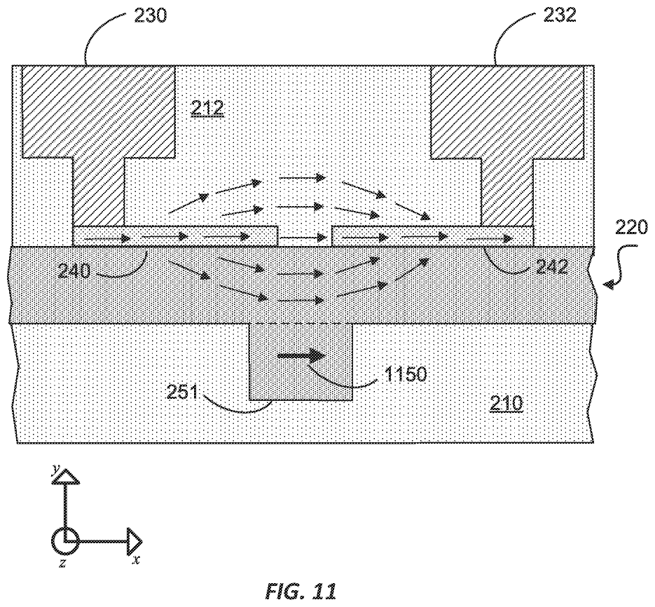

### FIG. 11—Induced Electric Field in a Photonic Phase Shifter

FIG. 11 is a simplified schematic diagram illustrating a cross section of the waveguide structure shown in FIG. 2, where the direction of the induced electric field is illustrated with arrows, according to some embodiments. As illustrated, the small arrows show the induced electric field direction which generally points along the positive x-direction through the electrodes of the device. The electric field curves in a convex manner both above and below the electrodes, as illustrated. Furthermore, the large arrow (1150) pointing in the positive x-direction illustrates the direction of polarization of an optical mode that may travel through the slab layer and the waveguide.

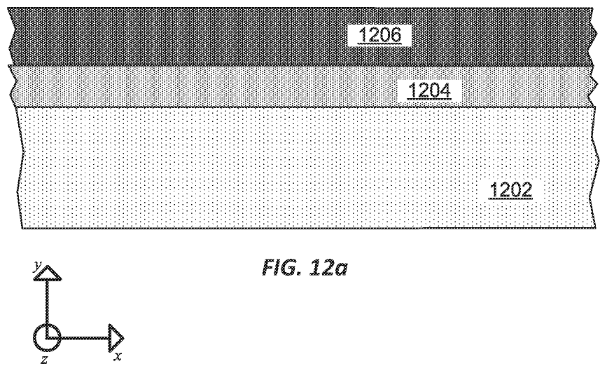

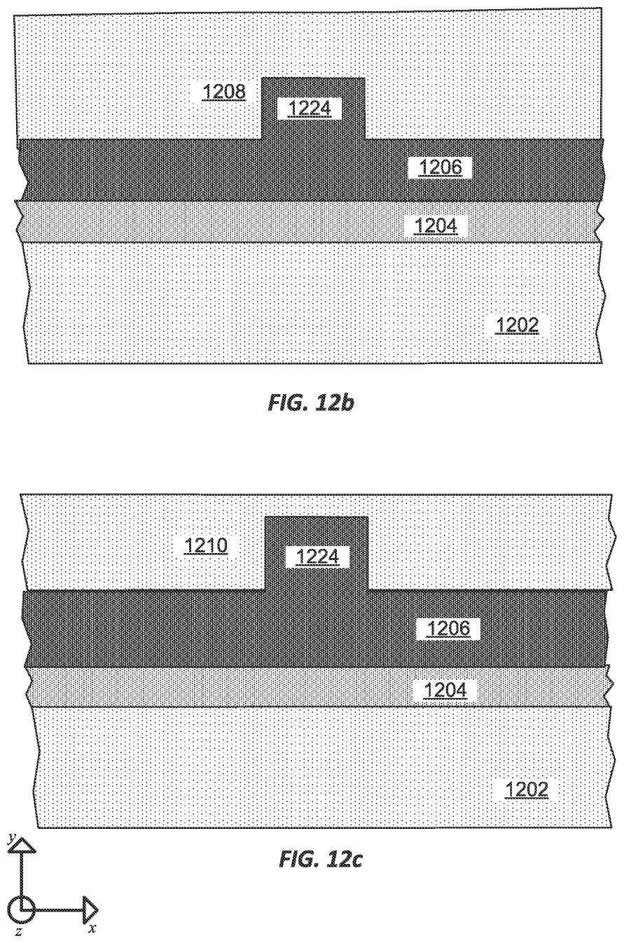

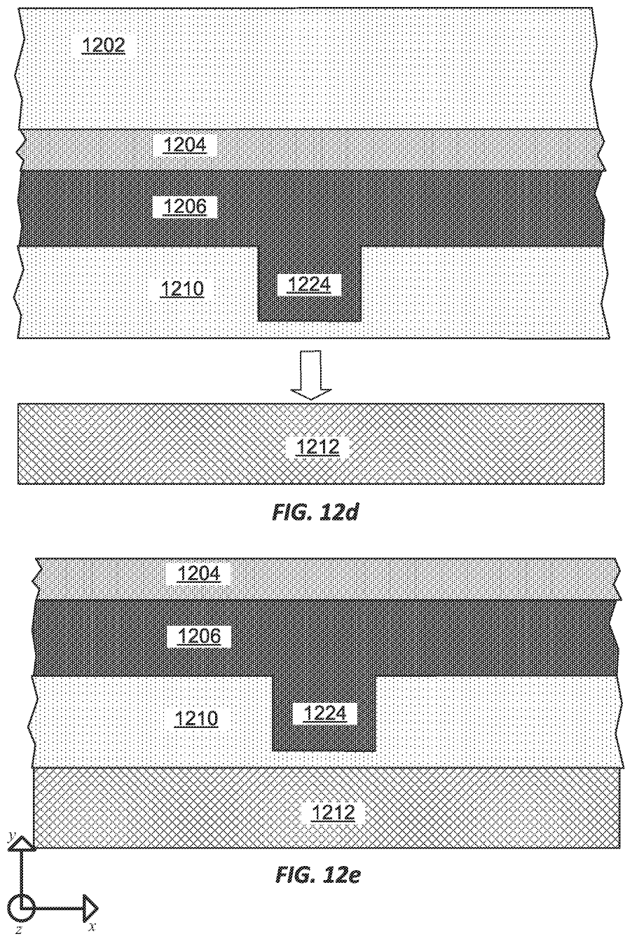

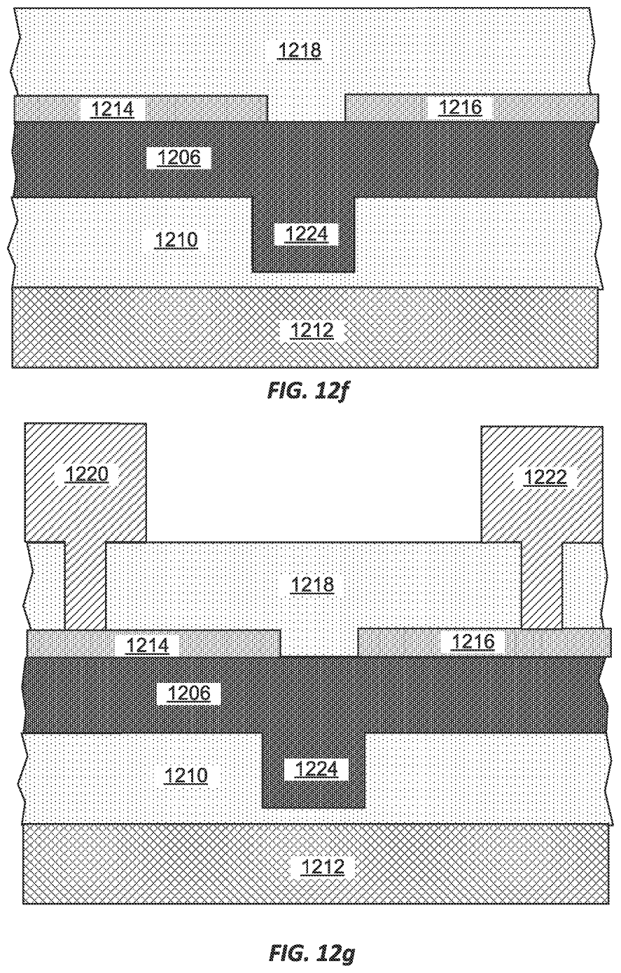

### FIGS. 12-15—Fabrication Methods for Electro-optical Devices

Recent technology advancements have demonstrated successful growth of ferroelectric thin films on planar Si substrates using complex molecular beam epitaxy (MBE) techniques, which makes it possible for monolithic integration of various complex oxides in electro-optical devices using semiconductor processing technologies. BaTiO₃ or BTO is considered the material of choice for next generation electro-optical switches due to its high Pockels coefficient, high band width, and low dielectric loss. In some embodiments, a blanket BTO thin film may be epitaxially grown on a silicon substrate using SrTiO₃ as a buffer. A silicon dioxide (SiO₂) bonding layer may be then overlaid on the BTO thin film. On another silicon wafer, a silicon waveguide is formed and is surrounded by a silicon dioxide cladding layer having a flat top surface, which can be obtained by, for example, chemical mechanical polishing after blanket deposition of the silicon dioxide layer over the silicon waveguide. The first wafer with the blanket BTO film formed thereon is bonded to the second wafer through wafer-to-wafer bonding, so that the blanket BTO film is transferred to the flat top surface of the silicon dioxide cladding on the second wafer. This first wafer is subsequently removed (e.g., by grinding and/or chemical mechanical polishing), and electrodes or contacts are then formed in the BTO film to allow application of an electric field across the contacts. This process involves transferring of the BTO film from one substrate to another, and is thus inefficient, costly, and limiting on the underlying device architecture. FIGS. 12-15 illustrate improved methods for the fabrication process of various electro-optical device architectures, according to various embodiments.

FIGS. 12A-G are schematic diagrams illustrating a fabrication method for constructing the electro-optical device with a ridge waveguide positioned opposite to the electrodes, according to some embodiments.

FIG. 12A illustrates initial steps for constructing a device, including depositing a seed layer (1204) on a substrate layer (1202), and depositing an electro-optic layer (1206) on the seed layer (1204). The sequential layers may be epitaxially deposited, or they may be deposited using another technique. In some embodiments, a first wafer comprising a first layer stack may be received, where the first layer stack includes the illustrated substrate layer (1202), seed layer (1204), and electro-optic layer (1206). In other words, a pre-fabricated wafer corresponding to that illustrated in FIG. 12A may be received from a manufacturer. Alternatively, a partially completed wafer comprising one or more of the seed layer (1204), substrate layer (1202), and/or electro-optic layer (1206) may be received, and the remaining layers may be deposited to complete the wafer.

In some embodiments, the substrate layer is a silicon-on-insulator (SOI) wafer, and the first portion of the substrate layer is a top silicon layer of the SOI wafer in contact with the seed layer. The SOI wafer may include a semiconductor (e.g., silicon or Si) base, an oxide layer (e.g., silicon dioxide or SiO₂) on the semiconductor base substrate, and a semiconductor layer (e.g., silicon) on the oxide layer. Although a silicon-based SOI substrate having a silicon layer on a silicon dioxide layer on a silicon base substrate is used herein as an example of the SOI substrate, the SOI substrate can be based on other types of semiconductors (e.g., germanium or gallium arsenide). The thickness of the silicon layer and the SiO₂ layer on the SOI substrate can vary according to various embodiments. In some embodiments, the thickness of the silicon layer on the SOI substrate is equal to or less than 150 nm, the thickness of the SiO₂ layer can range from 0.5 to 4 μm, and the thickness of the silicon base can range from 100 μm to 2 mm.

In some embodiments, the seed layer is composed of one of strontium titanate (STO), barium strontium titanate (BST), hafnium oxide, zirconium oxide, titanium oxide, graphene oxide, tantalum oxide, lead zirconium titanate (PZT), lead lanthanum zirconium titanate (PLZT), strontium barium niobate (SBN), magnesium oxide (MgO), germanium (Ge), or the like. In some embodiments, the seed layer may be thinner than 30 nm, and may serve as an interworking layer to attach the electro-optic layer to the substrate layer. In these embodiments, the seed layer and the interworking layer may ultimately be removed in a subsequent fabrication step. Alternatively, in some embodiments the seed layer may be thicker (e.g., from 4 nm-300 nm in thickness), and may be subsequently etched to split the seed layer into a first electrode separated from a second electrode, as described in greater detail below.

In some embodiments, the electro-optic layer is composed of one of barium titanate (BTO), barium strontium titanate (BST), lithium niobite, lead zirconium titanate (PZT), lead lanthanum zirconium titanate (PLZT), aluminum oxide, aluminum nitrite, or strontium barium niobate (SBN). In some embodiments, the first cladding layer may be composed of silicon dioxide, or another material.

In some embodiments, depositing the seed layer on the substrate layer includes obtaining an SOI substrate having a clean silicon surface (e.g., Si 2×1 reconstructed surface), and passivating the silicon surface using conventional techniques. After the silicon surface is passivated, a SrTiO₃ buffer layer can be epitaxially grown on the silicon layer. A thin film (˜3 nm to 30 nm) epitaxially grown SrTiO3 layer may be grown initially as a buffer layer to promote the epitaxial growth of the subsequently deposited BaTiO3 layer. In some embodiments, the first few MLs (1-3 ML) of SrTiO₃ can be grown at a lower temperature (e.g., 100-300° C.) under, for example, an oxygen pressure of 10⁻⁸-1.5×10⁻⁶ Torr, in order to avoid oxidation at the silicon surface. These few MLs of SrTiO₃ is mostly amorphous so an annealing process at higher temperature (e.g., 500-750° C.) in ultrahigh vacuum conditions (e.g., pressure <5×10⁻⁹ Torr) may be performed to crystallize the SrTiO₃ grown on the silicon surface. More SrTiO₃ may be then grown at higher temperature (e.g., 500-600° C.), or at lower temperature (e.g., 300-500° C.) followed by annealing at higher temperature (e.g., 550-750° C.) until a desired thickness of the SrTiO₃ buffer layer is achieved.

FIG. 12b illustrates how the electro-optic layer is etched to construct a ridge waveguide structure (1224). Subsequent to etching the electro-optic layer, a first cladding layer (1208) is deposited on the electro-optic layer (1206). For example, before depositing the first cladding layer, a ridge structure may be formed from a uniform electro-optic layer. In some embodiments, the ridge waveguide structure can be formed by obtaining an electro-optic layer with a e.g., 200-350 nm thickness, masking the area on the electro-optic layer where the ridge waveguide structure is to be situated, and etching the electro-optic layer on the SOI substrate using an anisotropic etching (e.g., RIE) process to thin down the unmasked portion of the electro-optic layer to, for example, less than 150 nm. The first cladding layer is then deposited on the ridge waveguide structure and the portion of the electro-optic layer that has been thinned down.

FIG. 12C illustrates planarizing the first cladding layer (1210). For example, the upper surface of the first cladding layer shown in FIG. 12A may not be sufficient planar, and the first cladding layer may be planarized to reduce variations in thickness of the first cladding layer.

FIG. 12D illustrates bonding the planarized first cladding layer (1210) to a wafer (1212). In some embodiments, the upper surface of the first cladding layer may be bonded to the wafer. In some embodiments, the wafer (1212) comprises an optical interposer, or the wafer may be another type of circuit component of the device. In general, the wafer may contain any of a variety of different types of components that are to be configured proximate to the ridge waveguide.

FIG. 12E illustrates removing the substrate layer (1202) from what is now shown as the upper surface of the device. Removing the substrate layer may expose the seed layer.

FIG. 12F illustrates etching the seed layer to split the seed layer into a first electrode (1214) separated from a second electrode (1216). Etching the seed layer may be performed to expose a portion of the electro-optic layer. The method may continue to deposit a second cladding layer (1218) on the etched seed layer and the exposed portion of the electro-optic layer.

FIG. 12G illustrates etching the second cladding layer to expose a first portion of the first electrode, etching the second cladding layer to expose a second portion of the second electrode, depositing a first lead (1220) onto the first electrode (1214) through the exposed first portion, and depositing a second lead (1222) onto the second electrode (1216) through the exposed second portion. The first and second leads may be composed of a conductive material such as a metal (e.g., copper, gold, or the like), or alternatively they may be composed of a semiconductor. The final device may be structurally similar to the device illustrated in FIG. 2, for example.

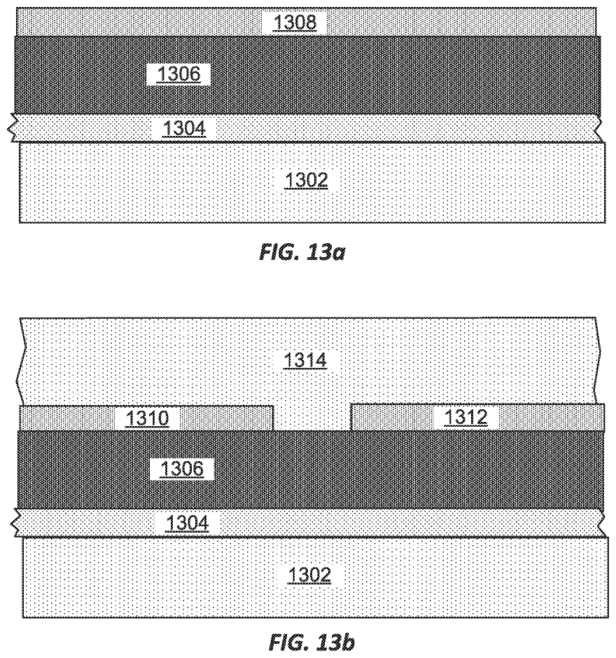

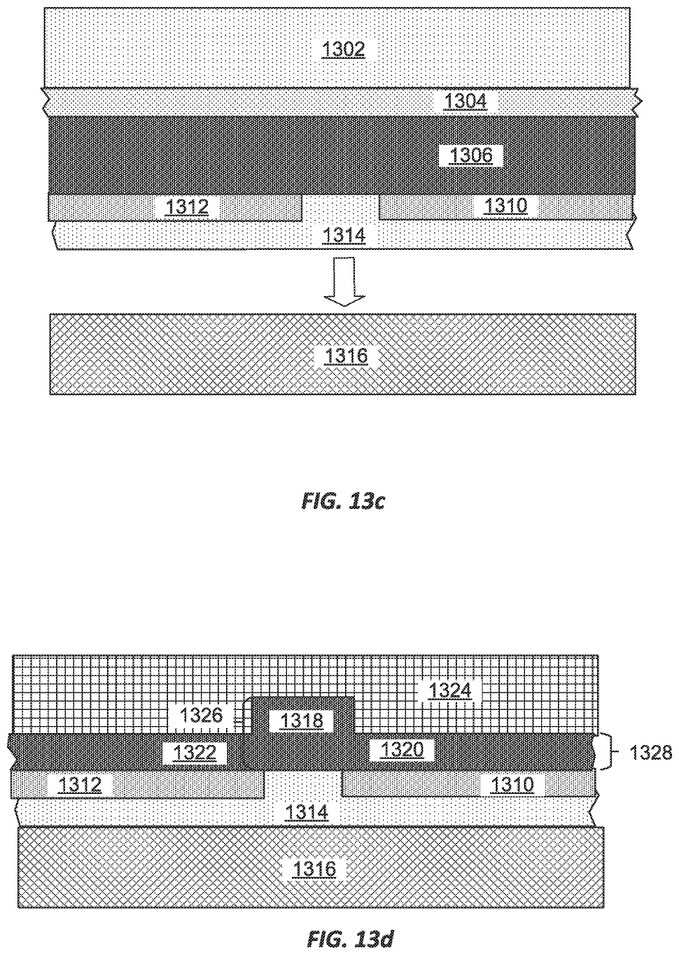

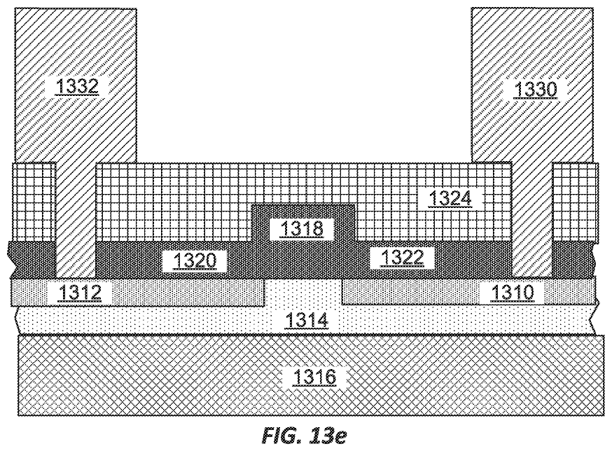

FIGS. 13A-E are schematic diagrams illustrating a fabrication method for constructing the electro-optical device with a ridge waveguide positioned on the opposite side as the electrodes with leads penetrating through the slab layer of the waveguide, according to some embodiments. The method steps shown in FIGS. 13A-E may be used to construct a device similar to the device shown in FIG. 3, for example.

FIG. 13A illustrates initial steps for fabricating a device, including depositing a seed layer (1304) on a substrate layer (1302), depositing an electro-optic layer (1306) on the seed layer (1304), and depositing an electrode layer (1308) on the electro-optic layer (1306). The sequential layers may be epitaxially deposited, or they may be deposited using another technique. Alternatively, a completed wafer such as that shown in FIG. 13A may be received from a manufacturer. Alternatively, a partially completed wafer comprising one or more of the seed layer (1304), substrate layer (1302), and/or electro-optic layer (1306) may be received, and the remaining layers may be deposited to complete the wafer.

In some embodiments, the seed layer is composed of one of strontium titanate (STO), barium strontium titanate (BST), hafnium oxide, zirconium oxide, titanium oxide, graphene oxide, tantalum oxide, lead zirconium titanate (PZT), lead lanthanum zirconium titanate (PLZT), strontium barium niobate (SBN), magnesium oxide (MgO), germanium, or the like.

In some embodiments, the electro-optic layer is composed of one of barium titanate (BTO), barium strontium titanate (BST), lithium niobite, lead zirconium titanate (PZT), lead lanthanum zirconium titanate (PLZT), aluminum oxide, aluminum nitrite, or strontium barium niobate (SBN).

FIG. 13B illustrates etching the electrode layer (1308) to expose a portion of the electro-optic layer and split the electrode layer into a first electrode (1310) separated from a second electrode (1312). Subsequent to performing the etching, a first cladding layer (1314) is deposited on the exposed portion of the electro-optic layer and the first and second electrodes.

FIG. 13C illustrates planarizing the first cladding layer and bonding the planarized first cladding layer (1314) to a wafer (1316). For example, the first cladding layer may be planarized to increase its thickness uniformity and to improve bonding to the wafer. The device may be flipped upside down prior to bonding to the wafer, such that the planarized first cladding layer is now on the bottom of the device for bonding to the wafer. In some embodiments, the wafer (1316) comprises an optical interposer, or the wafer may be another type of circuit component of the device. In general, the wafer may contain any of a variety of different types of components that are to be configured proximate to the electrodes.

FIG. 13D illustrates removing the substrate layer (1302) and the seed layer (1304), and after removing the substrate layer and the seed layer, etching the electro-optic layer (1306) to produce a ridge waveguide (1318) with a first thickness (1326) disposed between first (1320) and second (1322) slab layers with a second thickness (1328) smaller than the first thickness (1326). In some embodiments, to further improve the electro-optic coefficient in the region near the ridge waveguide, not just the substrate layer (1302) and the seed layer (1304) are removed but a portion of the electro-optic layer 1306 is also removed to remove any c-axis electro-optic material that was grown in the region close to the seed layer (e.g., in the case of an STO seed and BTO electro-optic layer). After etching the ridge waveguide, a second cladding layer (1324) may be deposited on the first and second slab layers and the ridge waveguide structure.

FIG. 13E illustrates etching through the second cladding layer (1324) and the first slab layer to expose a first portion of the first electrode, etching through the second cladding layer and the second slab layer to expose a second portion of the second electrode, depositing a first lead (1330) onto the first electrode (1310) through the exposed first portion, and depositing a second lead (1332) onto the second electrode (1312) through the exposed second portion. The first and second leads may be composed of a conductive material such as a metal, or alternatively they may be composed of a semiconductor.

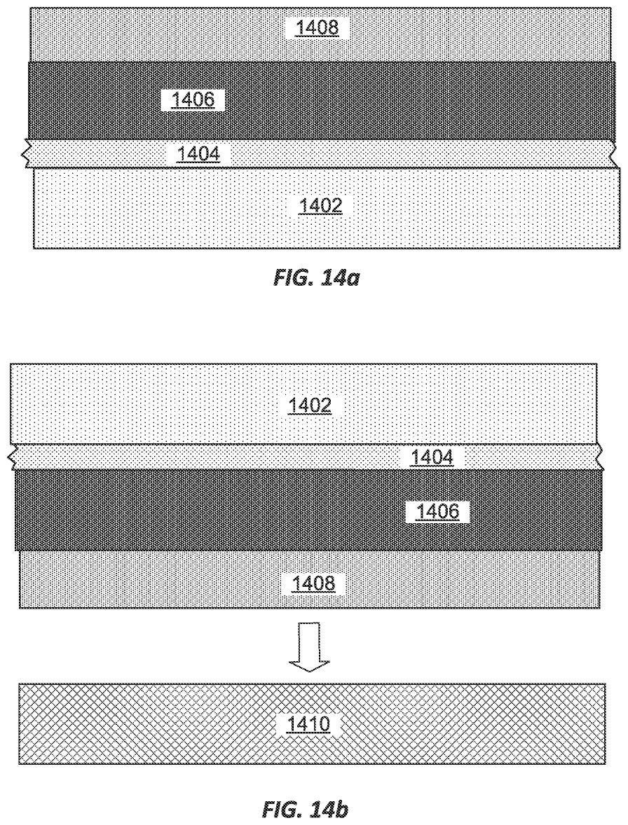

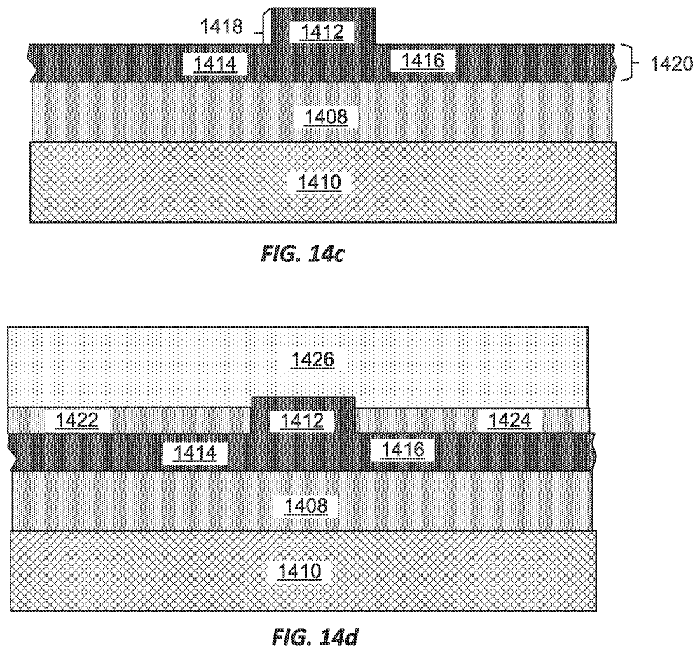

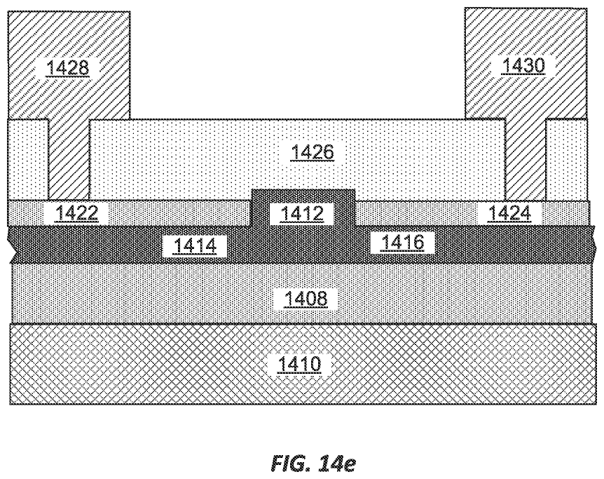

FIGS. 14A-E are schematic diagrams illustrating a fabrication method for constructing the electro-optical device with a ridge waveguide positioned on the same side as the electrodes, according to some embodiments. The method steps shown in FIGS. 14A-E may be used to construct a device similar to the device shown in FIG. 4, for example.

FIG. 14A illustrates initial steps for fabricating a device, including depositing a seed layer (1404) on a substrate layer (1402), depositing an electro-optic layer (1406) on the seed layer (1404), and depositing a first cladding layer (1408) on the electro-optic layer (1406). The sequential layers may be epitaxially deposited, or they may be deposited using another technique. Alternatively, a completed wafer such as that shown in FIG. 14A may be received from a manufacturer. Alternatively, a partially completed wafer comprising one or more of the seed layer (1404), substrate layer (1402), electro-optic layer (1406), and/or first cladding layer (1408) may be received, and the remaining layers may be deposited to complete the wafer.

In some embodiments, the electro-optic layer is composed of one of barium titanate (BTO), barium strontium titanate (BST), lithium niobite, lead zirconium titanate (PZT), lead lanthanum zirconium titanate (PLZT), aluminum oxide, aluminum nitrite, or strontium barium niobate (SBN).

FIG. 14B illustrates planarizing the first cladding layer (1408) to increase thickness uniformity of the first cladding layer, and bonding the planarized first cladding layer (1408) to a wafer (1410). The device may be flipped upside down prior to bonding to the wafer, such that the planarized first cladding layer is now on the bottom of the device for bonding to the wafer. In some embodiments, the wafer (1410) comprises an optical interposer, or the wafer may be another type of circuit component of the device. In general, the wafer may contain any of a variety of different types of components that are to be configured proximate to the seed layer.

FIG. 14C illustrates removing the substrate layer (1402) and the seed layer (1404), and after removing the substrate layer and the seed layer, etching the electro-optic layer to produce a ridge waveguide (1412) with a first thickness (1418) disposed between a first slab layer (1414) and a second slab layer (1416), wherein the first and second slab layers have a second thickness (1420) smaller than the first thickness (1418). In some embodiments, to further improve the electro-optic coefficient in the region near the ridge waveguide, not just the substrate layer (1402) and the seed layer (1404) are removed but a portion of the electro-optic layer 1406 is also removed to remove any c-axis electro-optic material that was grown in the region close to the seed layer (e.g., in the case of an STO seed and BTO electro-optic layer).

FIG. 14D illustrates depositing a first (1422) and second (1424) electrode on the left and right sides, respectively, of the ridge waveguide structure (1412), and depositing a second cladding layer (1426) on the first and second electrodes and the ridge waveguide structure. In some embodiments, the first and second electrodes are composed of one of strontium titanate (STO), barium strontium titanate (BST), hafnium oxide, zirconium oxide, titanium oxide, graphene oxide, tantalum oxide, lead zirconium titanate (PZT), lead lanthanum zirconium titanate (PLZT), or strontium barium niobate (SBN).

FIG. 14E illustrates etching through the second cladding layer to expose a first portion of the first electrode, etching through the second cladding layer to expose a second portion of the second electrode, depositing a first lead (1428) onto the first electrode (1422) through the exposed first portion, and depositing a second lead (1430) onto the second electrode (1424) through the exposed second portion. The first and second leads may be composed of a conductive material such as a metal, or alternatively they may be composed of a semiconductor.

FIG. 15A-E illustrate methods for fabricating a photonic device exhibiting a sandwich architecture, according to some embodiments. The method steps shown in FIGS. 15A-E may be used to construct a device similar to the device shown in FIG. 5, for example.

FIG. 15A illustrates a cross section of a first wafer (1,500) comprising an electrode layer (1504) disposed on a first substrate layer (1506) and an electro-optic layer (1502) disposed on the electrode layer (1504). Alternatively, in some embodiments the electro-optic layer (1502) is disposed on a seed layer (not shown). The first wafer may be prefabricated by a wafer manufacturer and received for further fabrication steps as described in FIGS. 15C-E, in some embodiments. Alternatively, the first wafer may be fabricated inhouse. For example, the electrode layer and the electro-optic layer may be sequentially deposited on the first substrate layer, by utilizing epitaxial deposition or any of a variety of other deposition techniques, as variously described throughout this disclosure.

FIG. 15B illustrates a cross section of a second wafer (1501) comprising a second substrate layer (1512) disposed underneath a second cladding layer (1510) and a second strip waveguide structure (1508) disposed within the second cladding layer and near the upper surface of the second cladding layer. The second wafer (1501) may be prefabricated by a wafer manufacturer and received for further fabrication steps as described in FIGS. 15C-E, in some embodiments. Alternatively, the second wafer may be fabricated in-house, as desired.

In some embodiments, the first wafer (1,500) is flipped over, and the exposed surface of the electro-optic layer (1502) of the first wafer is bonded to exposed surface of the second cladding layer (1510) of the second wafer. Accordingly, the first and second wafers are bonded together.

FIG. 15C illustrates how, in some embodiments, after bonding the first wafer to the second wafer, the first cladding layer (1506) is removed, and the electrode layer (1504) is etched to split the electrode layer into a first electrode (1514) separated from a second electrode (1516). In other embodiments, the electrode layer (1504) serves as a relatively thin seed layer that is ultimately removed. To further improve the electro-optic coefficient in the region near the surface of the seed layer, a portion of the electro-optic layer (1502) may be removed in addition to the substrate layer (1506) and the electrode/seed layer (1504). In these embodiments, after this removal of the seed layer, or any partial removal step, a new electrode layer may be deposited and etched as described above.

FIG. 15D illustrates how a first strip waveguide structure (1520) is deposited between the first (1514) and second (1516) electrodes. In some embodiments, the deposition process is followed by a planarization step to remove excess material from the region above the electrodes, e.g., by way of lithographic patterning or chemical mechanical polishing (CMP). In some embodiments, the material used for the strip waveguide structures (1520) and/or (1508) is as described above in reference to FIG. 5, and may be, e.g., silicon nitride. Subsequently, a first cladding layer (1518) is deposited on the first and second electrodes and the first strip waveguide structure.

Finally, FIG. 15E illustrates how the first cladding layer (1518) is etched to expose a portion of the first electrode (1514) and a portion of the second electrode (1516). A first lead (1522) is then deposited on the exposed portion of the first electrode, and a second lead (1524) is deposited on an exposed portion of the second electrode. FIG. 15E illustrates an embodiment where the lead is deposited on the upper surface of the first and second electrodes. However, in other embodiments, the exposed portions of the first and second electrodes may themselves be etched, such that the first and second leads are deposited within some distance within the cross section of the first and second electrodes, or potentially on the upper surface of the electro-optic layer (1502).

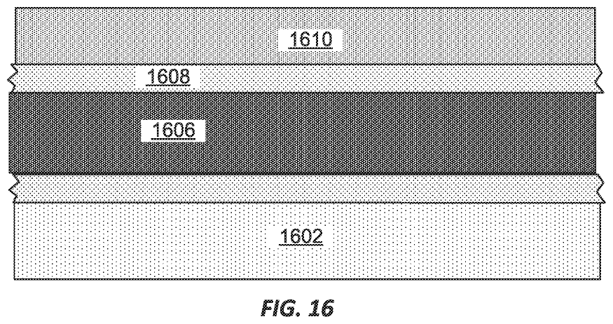

FIG. 16 illustrates a cross section of a first wafer including a layer stack that may be received as part of a fabrication process for various devices described herein, according to various embodiments. As illustrated, a first insulating substrate layer (1502) may be (optionally) disposed beneath a seed layer (1504), which is disposed beneath an electro-optic layer (1506), which is (optionally) disposed beneath an electrode layer (1508), which is (optionally) disposed beneath a second insulating substrate layer (1510). It is noted that the first wafer may be of various types depending on the specific fabrication method to be employed, as the seed layer, electrode layer, and second substrate layer may be optionally present or not present, as desired.

In some embodiments, the seed layer (1504) may be subsequently etched to form a first electrode separated from a second electrode. Alternatively, in some embodiments the seed layer simply serves to provide an interworking layer between the electro-optic layer and the first substrate layer, and the seed layer is ultimately removed during the fabrication process. In these embodiments, the electrode layer (1508) may be etched to form the first and second electrodes.

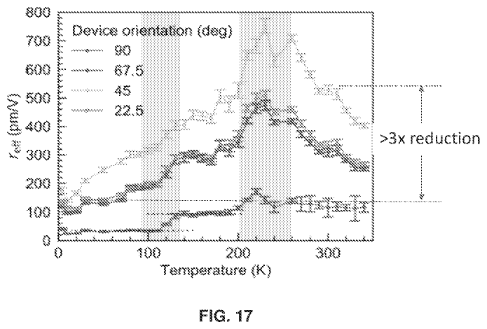

FIG. 17 is a plot of the effective Pockels coefficient for BTO vs. temperature. As described above, BTO is one of the materials that shows promise for use in quantum computing applications based on electro-optical switches because BTO has a relatively large Pockels coefficient. As shown in FIG. 17, the Pockels coefficient may be on the order of 500 pm/V to 550 pm/V for a BTO thin film at room temperature. However, electro-optic materials, such as BTO, show a reduced Pockels coefficient at cryogenic temperatures (e.g., below 5 K), which are the temperatures that are of interest for quantum computing applications. As shown in FIG. 17, for example, the Pockels coefficient of BTO is reduced by greater than a factor of three at 4 K relative to its value at room temperature. The reduction of the Pockels coefficient may be due to structural phase transitions and reduction of phonon softening that may occur as the temperature is reduced.

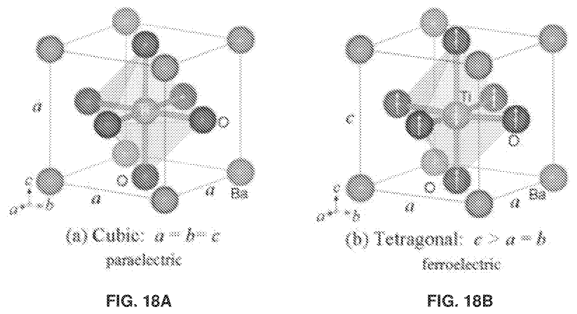

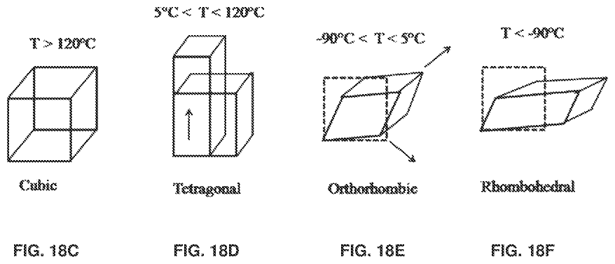

FIG. 18A is an illustration of the crystallographic unit cell of BTO in the cubic phase, and FIG. 18B is an illustration of the crystallographic unit cell of BTO in the tetragonal phase. The electro-optic properties of BTO depend on the crystal symmetry of the material. In this regard, the cubic phase illustrated in FIG. 18A is highly symmetric and therefore does not have an electric dipole moment. As such, the cubic phase is paraelectric and has a low value of the Pockels coefficient. In contrast, the tetragonal phase of BTO, illustrated in FIG. 18B, has a reduced crystal symmetry. In this regard, the unit cell (i.e., the unit cell lattice constant or parameter) is longer along the c-axis than it is along the a-axis and the b-axis. As such, the tetragonal phase possesses an electric dipole moment and is therefore ferroelectric. The lower symmetry of the tetragonal phase also gives rise to a larger value of the Pockels coefficient. Various crystal phases are stable in respective temperature ranges, as described in greater detail with reference to FIGS. 18C to 18F, below.

FIGS. 18C to 18F schematically illustrate various crystallographic phases of BTO in respective temperature ranges for bulk BTO. In this regard, the cubic phase is stable for temperatures greater than 120° C. (393.2 K), as shown in FIG. 18C, the tetragonal phase is stable for temperatures in the range from 5° C. to 120° C. (278.2 K to 393.2 K), as shown in FIG. 18D, the orthorhombic phase is stable for temperatures in the range from −90° C. to 5° C. (183.2 K to 278.2 K), as shown in FIG. 18E, and the rhombohedral phase is stable for temperatures less than −90° C. (183.2 K), as shown in FIG. 18F. Thus, for cryogenic temperatures (e.g., below 5 K, such as around 4 K), the rhombohedral phase is stable for bulk materials. Without wishing to be bound by a particular theory this may partially account for the low value of the Pockels coefficient at low temperatures. However, it is possible that other BTO phase(s) may exist at cryogenic temperatures.

The thermal contraction of the crystal structure with reduced temperature may further cause a relative strengthening of inter-atomic bonds. As such, individual atoms experience greater forces vs. displacement (i.e., phonon stiffening) which may reduce the degree to which atoms may be displaced relative to one another in the presence of applied electric fields. As such, the induced electric dipole moment vs. applied electric field may be reduced. This effect may also contribute to a reduction in the Pockels coefficient. In various embodiments described below a thin film geometry including an interlayer may be used to induce a predetermined strain on an electro-optic layer that may stabilize the desired tetragonal phase with “a-axis” crystal structure configuration at lower temperatures.

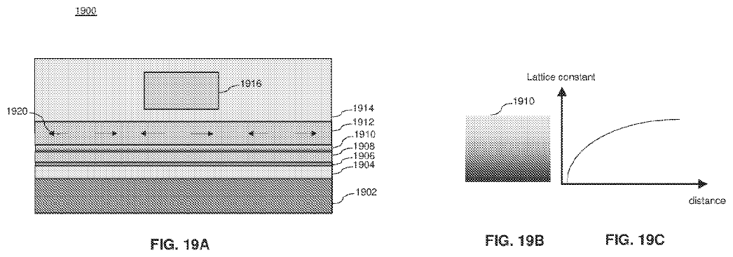

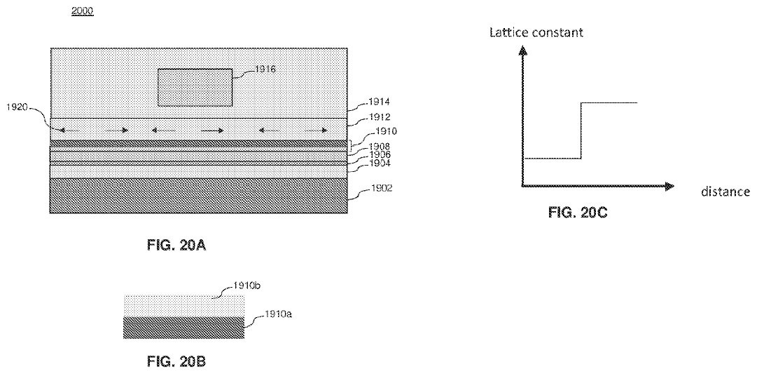

The following approaches implement an interlayer with a lattice that is graded (e.g., linear grade or step function) to stabilize the top level BTO into a film. In some example embodiments, the interlayer is configured with different lattice constants versus distance profiles. For example, the lattice constant versus distance profile can be linear or polynomial as discussed with reference to FIG. 19C, in accordance with some example embodiments. As an additional example, the lattice constant versus distance profile of the interlayer can be a step function, where multiple layers of the interposer are disposed to create a stepped lattice gradient interposer in a BTO stack device, discussed below with reference to FIG. 20C.

As illustrated in FIG. 19A, a vertical cross-sectional view of an electro-optic device (1900) comprises an interlayer (1910) that may be used to generate a predetermined strain in an electro-optic material, according to various embodiments. In this regard, the electro-optic device (1900) may include a substrate (1902, 1904), a seed layer (1906), an optional first electro-optic layer (1908) (e.g., lower ferroelectric electro-optic layer), the interlayer (1910), the second electro-optic layer (1912) (e.g., upper ferroelectric electro-optic layer), a cladding layer (1914), and a waveguide core structure (1916). The substrate may include a single crystal semiconductor layer (1902) and an oxide layer (1902). For example, the single crystal semiconductor layer (1902) may be a single crystal silicon layer or wafer and the oxide layer (1902) may be a first layer of silicon oxide. Other substrates, such as other semiconductor, insulating and/or conductive substrates may also be used. The optional seed layer (1906) may be a layer of STO and the optional first electro-optic layer (1908) may be a first layer of BTO. The second electro-optic layer (1912) may be a second layer of BTO and the cladding layer (1914) may be second layer of silicon oxide. As described above with respect to other embodiments, the waveguide core structure (1916) may be a silicon nitride waveguide core. Other suitable core and cladding materials may also be used.

Various materials may be chosen for the interlayer (1910). For example, the interlayer may include a titanium rich BTO having a greater atomic concentration of Ti than Ba. The titanium rich BTO may comprise Ba₁₋ₓTi₁₊ₓO_{3+d} in which 0.1≤x≤0.75, such as 0.2≤x≤0.7, such as 0.4≤x≤0.6, and 0≤d<0.1. For example, x may range from 0.45 to 0.55, such as about 0.5, and d may be 0.05 or less, such as about zero. In contrast, the second electro-optic layer (1912) may be a second layer of stoichiometric or near stoichiometric BTO comprising Ba_{1+y}Ti_{1+z}O_{3±d} in which −0.1<y<0.1, −0.1<<0.1 and 0≤d<0.1. For example, y and z may each independently range between −0.05 and 0.05, such as about zero. In one embodiment, the titanium rich BTO interlayer may have a larger in-plane and out-of-plane lattice constants (i.e., lattice parameters) than those of the stoichiometric or near stoichiometric BTO.

In one embodiment, the interlayer (1910) may have a compositional gradient. FIG. 19B is a schematic illustration of a compositional gradient of the interlayer (1910) of FIG. 19A, and FIG. 19C is a graphical illustration of the compositional gradient of the interlayer (1910) of FIG. 19A, according to an embodiment. The interlayer may include a material that has a compositional gradient that varies with distance from the bottom of the interlayer (1910) to the top of the interlayer (1910). For example, the composition may be chosen to have a lattice constant that varies continuously from the bottom of the interlayer (1910) to the top of the interlayer (1910). In this example, embodiment, the material composition may be chosen such that the lattice constant increases from the bottom of the interlayer (1910) (located closer to the seed layer) to the top of the interlayer (1910) (located farther from the seed layer), as shown in FIG. 19C. Similarly, the shading shown in FIG. 19B schematically indicates that compositional gradient.

Various materials may be chosen for the graded interlayer (1910). In one embodiment, the interlayer may include a titanium rich BTO having a greater atomic concentration of Ti than Ba in which the concentration Ti increases with layer thickness (i.e., which increases from the bottom of the interlayer (1910) to the top of the interlayer (1910)). The interlayer (1910) may include a first alloy of Ba, Ti, and O having the chemical formula Ba₁₋ₓTi₁₊ₓO_{3±d}. As such, the material may be formed such that the Ti fraction “x” increases with distance from the bottom of the interlayer (1910) to the top of the interlayer.

In another embodiment, the graded interlayer (1910) may include a second alloy of Ba, Sr, Ti, and O (i.e., barium strontium titanate, (BST)) having the chemical formula Ba_{1-q}Sr_{q}TiO_{3±d}. By varying the Ba/Sr ratio one may change the lattice parameter of the alloy without changing the crystal phase (perovskite phase). A higher fraction of Ba relative to Sr may have a larger lattice constant. As such, the material may be formed such that the Sr fraction “q” decreases with distance from the bottom of the interlayer (1910) to the top of the interlayer so that the lattice constant of the interlayer (1910) increases from the bottom to the top of the interlayer (1910).

In a further embodiment, the interlayer (1910) may include a third alloy of Ba, Sr, Ti, and O having the chemical formula Ba₁₋ⱼSrⱼO_{1±d} (BSO). As with the second alloy, a higher fraction of Ba relative to Sr may have a larger lattice constant. As such, the material may be formed such that the Sr fraction “j” decreases with distance from the bottom of the interlayer (1910) to the top of the interlayer. In some example embodiments, the interlayer is formed using molecular beam epitaxy (e.g., to grow BTO on silicon), while in other example embodiments, the interlayer is formed using other fabrication techniques, such as chemical vapor deposition, physical vapor deposition, etc.

FIG. 20A is a vertical cross-sectional view of an electro-optic device (2000) having an interlayer (1910) that may be used to generate a predetermined strain in an electro-optic material, according to various embodiments. The electro-optic device (2000) may include a similar structure to that of the electro-optic device (1900) of FIG. 19A, except rather than including a graded interlayer (1910), shown in FIG. 19B, the interlayer (1910) in this embodiment includes two or more discrete sublayers (1910a), (1910b) having a different composition and lattice constant.

FIG. 20B is a schematic illustration of the composition profile of the interlayer (1910) of FIG. 20A, and FIG. 20C is a graphical illustration of a composition profile of the interlayer (1910) of FIG. 20A, according to an embodiment. In the example embodiment of FIG. 20B, the inter-layer comprises multiple layers with different lattice constants for improved BTO stabilization. In this example embodiment, the interlayer (1910) may include a first portion (1910a) and a second portion (1910b) as shown, for example, in FIG. 20B. The first portion (1910a) located closer to the seed layer may include a first material having a first lattice constant and the second portion (1910b) located farther from the seed layer may include a second material having a second lattice constant. As shown in FIG. 20C, for example, the first lattice constant may be smaller than the second lattice constant. Various materials may be used for the first portion (1910a) and the second portion (1910b). For example, various combinations of TiO₂, STO, BST, MgO, LaAlO₃, BaSnO₃, BaHfO₃, BaZrO₃, SrSnO₃, and SrNbO₃ may be used. Although this example embodiment only includes an interlayer (1910) have two components (i.e., the first portion (1910a) and the second portion (1910b)), various other embodiments may include three or more discrete sublayers. In some example embodiments, the multi-layer interlayer is formed using molecular beam epitaxy (e.g., to grow BTO on silicon), while in other example embodiments, the interlayer is formed using other fabrication techniques, such as chemical vapor deposition, physical vapor deposition, etc., to fabricate the different layers.

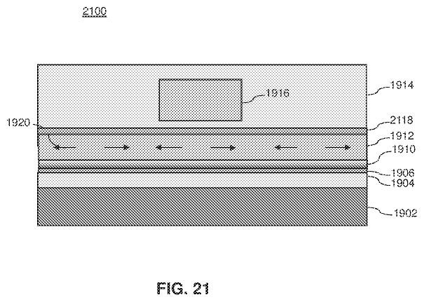

FIG. 21 is a vertical cross-sectional view of an electro-optic device (2100) according to an alternative embodiment in which the optional first electro-optic layer (1908) is omitted. In this embodiment, the interlayer (1910) may be located directly on the seed layer (1906). Optionally, a STO cap layer (2118) may be added between the electro-optic layer (1912) and the cladding layer (1914).

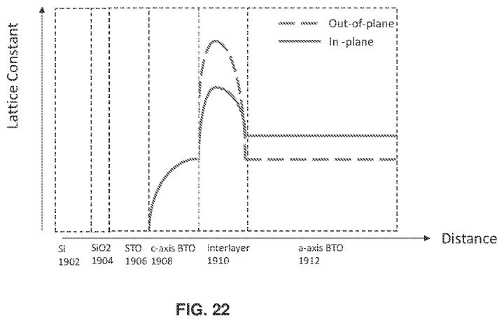

FIG. 22 is a schematic illustration of the in-plane vs. out-of-plane lattice constant of an electro-optic device (1900), (2000) or (2100), according to various embodiments. Without wishing to be bound by a particular theory, the present inventors believe that the strain generated by the interlayer (1910) on the electro-optic layer (e.g., BTO layer) (1912) stabilizes the tetragonal phase in the BTO layer (1912) with an a-axis orientation. As used herein, the a-axis orientation means that all or a majority of the crystal grains in a polycrystalline BTO layer (1912) have a tetragonal crystal structure with the a-axis perpendicular to the top surface of the BTO layer (1912) and the c-axis parallel to the top surface of the BTO layer (1912), while a single crystalline BTO layer (1912) has a tetragonal crystal structure with the a-axis perpendicular to the top surface of the BTO layer (1912) and the c-axis parallel to the top surface of the BTO layer (1912).

Thus, the in-plane lattice constant (i.e., the c-axis lattice constant parallel to the top surface) of the BTO layer (1912) is longer than the out-of-plane lattice constant (i.e., the a-axis lattice constant perpendicular to the top surface) of the a-axis BTO layer (1912). It is believed that such a-axis BTO layer (1912) has all or a majority of the ferroelectric dipoles (1920) located parallel to the top surface of the BTO layer (1912). It is also believed that such a-axis BTO layer has an increased effective Pockels coefficient at cryogenic temperatures than a c-axis BTO layer.

In contrast, the optional first electro-optic layer (1908) located below the interlayer (1910) may comprise the c-axis BTO layer having its c-axis perpendicular to the top surface and its a-axis parallel to the top surface. Thus, its out-of-plane lattice constant is longer than its in-plane lattice constant. Likewise, if the interlayer (1910) comprises a Ti-rich BTO layer, then it may also have the out-of-plane lattice constant that is longer than its in-plane lattice constant.

In one embodiment, the electro-optic device (1900), (2000) or (2100) includes an interlayer (1910) and a ferroelectric electro-optic layer (1912). The interlayer generates a strain in the ferroelectric electro-optic layer such that an in-plane lattice constant of the ferroelectric electro-optic layer is longer than an out-of-plane lattice constant of the ferroelectric electro-optic layer.

In one embodiment, the ferroelectric electro-optic layer comprises a ferroelectric barium titanate (BTO) layer having a tetragonal crystal structure with a c-axis parallel to an upper surface of the ferroelectric BTO layer and an a-axis perpendicular to the upper surface of the ferroelectric BTO layer. In one embodiment, the interlayer comprises a titanium-rich BTO layer. In one embodiment, the interlayer comprises a graded layer having a longer lattice constant closer to the ferroelectric BTO layer than farther from the ferroelectric BTO layer. In one embodiment, an in-plane lattice constant of the interlayer is shorter than an out-of-plane lattice constant of the interlayer. In one embodiment, the ferroelectric dipoles (1920) in the ferroelectric BTO layer are arranged parallel to the upper surface of the ferroelectric BTO layer.

### The Following are Example Embodiments:

Example 1. An electro-optic device, comprising: an interlayer; and a ferroelectric electro-optic layer, wherein the interlayer generates a strain in the ferroelectric electro-optic layer such that an in-plane lattice constant of the ferroelectric electro-optic layer is longer than an out-of-plane lattice constant of the ferroelectric electro-optic layer.

Example 2. The electro-optic device of example 1, wherein the ferroelectric electro-optic layer comprises a ferroelectric barium titanate (BTO) layer having a tetragonal crystal structure with a c-axis parallel to an upper surface of the ferroelectric BTO layer and an a-axis perpendicular to the upper surface of the ferroelectric BTO layer.

Example 3. The electro-optic device of any of examples 1 or 2, wherein the interlayer comprises a titanium-rich BTO layer.

Example 4. The electro-optic device of any of examples 1-3, wherein the interlayer comprises a graded layer having a longer lattice constant closer to the ferroelectric BTO layer than farther from the ferroelectric BTO layer.

Example 5. The electro-optic device of any of examples 1-4, wherein an in-plane lattice constant of the interlayer is shorter than an out-of-plane lattice constant of the interlayer.

Example 6. The electro-optic device of any of examples 1-5, wherein ferroelectric dipoles in the ferroelectric BTO layer are arranged parallel to the upper surface of the ferroelectric BTO layer.

Example 7. A method of manufacturing an electro-optic device, comprising: forming a ferroelectric electro-optic layer; and forming an interlayer that interfaces with the ferroelectric electro-optic layer, the interlayer generating a strain in the ferroelectric electro-optic layer such that an in-plane lattice constant of the ferroelectric electro-optic layer is longer than an out-of-plane lattice constant of the ferroelectric electro-optic layer.

Example 8. The method of example 7, wherein the ferroelectric electro-optic layer comprises a ferroelectric barium titanate (BTO) layer.

Example 9. The method of any of examples 7 or 8, wherein the ferroelectric barium titanate (BTO) layer comprises a tetragonal crystal structure with a c-axis parallel to an upper surface of the ferroelectric BTO layer and an a-axis perpendicular to the upper surface of the ferroelectric BTO layer.

Example 10. The method of any of examples 7-9, wherein the interlayer comprises a titanium-rich BTO layer.

Example 11. The method of any of examples 7-10, wherein the interlayer comprises a graded layer having a longer lattice constant closer to the ferroelectric BTO layer than farther from the ferroelectric BTO layer.

Example 12. The method of any of examples 7-11, wherein an inplane lattice constant of the interlayer is shorter than an out-of-plane lattice constant of the interlayer.

Example 13. The method of any of examples 7-12, wherein ferroelectric dipoles in the ferroelectric BTO layer are arranged parallel to the upper surface of the ferroelectric BTO layer.

Example 14. The method of any of examples 7-13, wherein forming the ferroelectric electro-optic layer comprises epitaxially growing the ferroelectric electro-optic layer.

Example 15. The method of any of examples 7-14, wherein forming the interlayer comprises epitaxially growing the interlayer.

Example 16. The method of any of examples 7-15, wherein forming the interlayer comprises depositing the interlayer using vapor deposition.

Example 17. The method of any of examples 7-16, wherein the interlayer comprises a first layer having a first lattice constant and a second layer having a second lattice constant.

Example 18. The method of any of examples 7-17, wherein the first layer comprises a first material having a first lattice constant and the second layer comprises a second material that is different from the first material and the second material exhibits a second lattice constant that is longer than the first lattice constant.

Example 19. The method of any of examples 7-18, wherein the interlayer interfaces with the ferroelectric electro-optic layer such that the second material having a longer lattice is constant is closer to the ferroelectric electro-optic layer.

Example 20. The method of any of examples 7-19, wherein a lower ferroelectric electro-optic layer is formed on a substrate, and the interlayer is formed on the lower ferroelectric electro-optic layer, and the ferroelectric electro-optic layer is an upper ferroelectric electro-optic layer and wherein the upper ferroelectric electro-optic layer is formed on the interlayer such that the first layer of interlayer that has the first lattice constant is closer to the lower ferroelectric electro-optic layer and the second layer of the interlayer is closer to the upper ferroelectric electro-optic layer.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An electro-optic device, comprising:
an interlayer; and
a ferroelectric electro-optic layer,
wherein the interlayer generates a strain in the ferroelectric electro-optic layer such that an in-plane lattice constant of the ferroelectric electro-optic layer is longer than an out-of-plane lattice constant of the ferroelectric electro-optic layer.

2. The electro-optic device of claim 1, wherein the ferroelectric electro-optic layer comprises a ferroelectric barium titanate (BTO) layer having a tetragonal crystal structure with a c-axis parallel to an upper surface of the ferroelectric BTO layer and an a-axis perpendicular to the upper surface of the ferroelectric BTO layer.

3. The electro-optic device of claim 2, wherein the interlayer comprises a titanium-rich BTO layer.

4. The electro-optic device of claim 2, wherein the interlayer comprises a graded layer having a longer lattice constant closer to the ferroelectric BTO layer than farther from the ferroelectric BTO layer.

5. The electro-optic device of claim 2, wherein an in-plane lattice constant of the interlayer is shorter than an out-of-plane lattice constant of the interlayer.

6. The electro-optic device of claim 2, wherein ferroelectric dipoles in the ferroelectric BTO layer are arranged parallel to the upper surface of the ferroelectric BTO layer.

7. A method of manufacturing an electro-optic device, comprising:
forming a ferroelectric electro-optic layer; and
forming an interlayer that interfaces with the ferroelectric electro-optic layer, the interlayer generating a strain in the ferroelectric electro-optic layer such that an in-plane lattice constant of the ferroelectric electro-optic layer is longer than an out-of-plane lattice constant of the ferroelectric electro-optic layer.

8. The method of claim 7, wherein the ferroelectric electro-optic layer comprises a ferroelectric barium titanate (BTO) layer.

9. The method of claim 8, wherein the ferroelectric barium titanate (BTO) layer comprises a tetragonal crystal structure with a c-axis parallel to an upper surface of the ferroelectric BTO layer and an a-axis perpendicular to the upper surface of the ferroelectric BTO layer.

10. The method of claim 8, wherein the interlayer comprises a titanium-rich BTO layer.

11. The method of claim 8, wherein the interlayer comprises a graded layer having a longer lattice constant closer to the ferroelectric BTO layer than farther from the ferroelectric BTO layer.

12. The method of claim 8, wherein an in-plane lattice constant of the interlayer is shorter than an out-of-plane lattice constant of the interlayer.

13. The method of claim 9, wherein ferroelectric dipoles in the ferroelectric BTO layer are arranged parallel to the upper surface of the ferroelectric BTO layer.

14. The method of claim 7, wherein forming the ferroelectric electro-optic layer comprises epitaxially growing the ferroelectric electro-optic layer.

15. The method of claim 7, wherein forming the interlayer comprises epitaxially growing the interlayer.

16. The method of claim 7, wherein forming the interlayer comprises depositing the interlayer using vapor deposition.

17. The method of claim 7, wherein the interlayer comprises a first layer having a first lattice constant and a second layer having a second lattice constant.

18. The method of claim 17, wherein the first layer comprises a first material having a first lattice constant and the second layer comprises a second material that is different from the first material and the second material exhibits a second lattice constant that is longer than the first lattice constant.

19. The method of claim 18, wherein the interlayer interfaces with the ferroelectric electro-optic layer such that the second material having a longer lattice is constant is closer to the ferroelectric electro-optic layer.

20. The method of claim 19, wherein a lower ferroelectric electro-optic layer is formed on a substrate, and the interlayer is formed on the lower ferroelectric electro-optic layer, and the ferroelectric electro-optic layer is an upper ferroelectric electro-optic layer and wherein the upper ferroelectric electro-optic layer is formed on the interlayer such that the first layer of interlayer that has the first lattice constant is closer to the lower ferroelectric electro-optic layer and the second layer of the interlayer is closer to the upper ferroelectric electro-optic layer.
